(19) United States
(12) Patent Application Publication
(10) Pub. No.: US 2025/0307238 A1
(43) Pub. Date: Oct. 2, 2025

(54) QUERY LANGUAGE QUERY GENERATION AND REPAIR

(71) Applicant: Microsoft Technology Licensing, LLC, Redmond, WA (US)

(72) Inventors: Alexander KLEIN, Seattle, WA (US); Xinye TANG, Issaquah, WA (US); Ye XING, Wellesley, MA (US)

(21) Appl. No.: 18/622,336

(22) Filed: Mar. 29, 2024

(51) Int. Cl. G06F 16/242; G06N 3/0455; G06N 3/084

(52) U.S. Cl. CPC G06F 16/2438; G06F 16/243; G06N 3/0455; G06N 3/084

(57) ABSTRACT

Systems, methods, devices, and computer readable storage media described herein provide techniques for generating and/or repairing query language (QL) queries. In an aspect, an embedding is determined based on a request to generate a QL query. The embedding is compared to a layer embedding(s) of a deep data map to determine a similarity between a layer embedding and the embedding satisfies similarity criteria. A prompt is provided to a large language (LLM) to cause the LLM to generate the QL query, the prompt comprising a description of an item associated with the layer embedding. In another aspect, an alert indicating an undefined variable of the QL query is received. A query embedding associated with the QL query is compared to the layer embedding(s) to determine a candidate variable. The candidate variable is substituted in for the undefined variable, and a response comprising the repaired QL query is generated.

### BACKGROUND

Queries made in a query language can be used for performing database operations such as retrieving and/or transforming records within a database. A query language query relies on two sources of knowledge: knowledge of the language and knowledge of the database. A system for generating queries in the query language may have parametric knowledge of the language. For instance, a system utilizes a generative AI model trained on a large corpus of information to generate a query language query. The large corpus of information may or may not be specialized to the knowledge of the database.

Generative AI models may experience “hallucination” where the generative AI model generates incorrect or misleading results. Some implementations of query language generation implement post-processing techniques to validate and/or repair queries generated by the generative AI model. For example, an implementation of a query language generation system repairs an invalid query by re-prompting the generative AI model to generate a new query, which takes time and expends additional compute resources associated with the generative AI model.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some embodiments are described herein for prompting a generative artificial intelligence (AI) model (e.g., a large language model (LLM) or other type of generative AI model) to generate a query language (QL) query. In an aspect, a request associated with querying a database is received. A request embedding is determined based on the request. The request embedding is compared to a first layer embedding of a deep data map to determine a similarity between the request embedding and the first layer embedding satisfies first similarity criteria. The first layer embedding describes a value within a database. A ranked item is determined based on the first layer embedding. A description of the ranked item is included in a prompt. The prompt is provided to the LLM to cause the LLM to generate a QL query.

In a further aspect, the request embedding is compared to a second layer embedding of the deep data map to determine a similarity between the request embedding and the second layer embedding satisfies second similarity criteria. The first layer embedding is dependent on the second layer embedding.

In a further aspect, descriptions of tables of the database are received. The descriptions of the tables are provided to an embedding model configured to generate embeddings based on input data. The deep data map is received from the embedding model.

Some embodiments are described herein for correcting output of a generative AI model. In an aspect, a first alert indicating a first variable of a query language query generated by the generative AI model is undefined is received. The query language query corresponds to a prompt previously provided to the generative AI model. A first query embedding associated with the query language query and corresponding to the undefined first variable is received. The first query embedding is compared to a set of database embeddings to determine a first candidate variable. The first candidate variable is associated with a first database embedding of the set of database embeddings. A similarity between the first query embedding and the first database embedding satisfies similarity criteria. The first candidate variable is substituted in for the first variable in the query language query to generate a first repaired query language query. A first response comprising the first repaired query language query is generated.

In a further aspect, the first response is returned as a response of the generative AI model.

In a further aspect, the first response is provided to a query parser to cause the query parser to determine if the first repaired query language query is valid.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for query generation and repair, in accordance with an example embodiment.

FIG. 2 shows a block diagram of a system for generating a deep data map, in accordance with an example embodiment.

FIG. 3 shows a flowchart of a process for generating a deep data map, in accordance with an example embodiment.

FIG. 4 shows a flowchart of a process for pre-processing descriptions, in accordance with an example embodiment.

FIG. 5 shows a flowchart of a process for updating a deep data map, in accordance with an example embodiment.

FIG. 6 shows a block diagram of a system for prompting a generative AI model to generate a query language query, in accordance with another example embodiment.

FIG. 7 shows a flowchart of a process for prompting a generative AI model to generate a query language query, in accordance with an example embodiment.

FIG. 8 shows a block diagram of a system for determining a ranked item, in accordance with an example embodiment.

FIG. 9 shows a flowchart of a process for determining a candidate item, in accordance with an example embodiment.

FIG. 10 shows a block diagram of a system for repairing a query generated by a generative AI model, in accordance with an example embodiment.

FIG. 11 shows a flowchart of a process for repairing a query generated by a generative AI model, in accordance with an example embodiment.

FIG. 12 shows a flowchart of a process for returning a response on behalf of a generative AI model, in accordance with an example embodiment.

FIG. 13 shows a block diagram of a system for repairing a query and returning a response on behalf of a generative AI model, in accordance with an example embodiment.

FIG. 14 shows a flowchart of a process for iteratively repairing a query generated by a generative AI model, in accordance with an example embodiment.

FIG. 15 shows a flowchart of a process for returning a query generated by a generative AI model on behalf of the generative AI model, in accordance with an example embodiment.

FIG. 16 shows a flowchart of a process for determining exit criteria is met, in accordance with an example embodiment.

FIG. 17 shows a block diagram of a system for repairing a query generated by a generative AI model, in accordance with another example embodiment.

FIG. 18 shows a flowchart of a process for determining a candidate variable, in accordance with an example embodiment.

FIG. 19 depicts an example illustration of tables of a database, in accordance with an example embodiment.

FIG. 20 shows a flowchart of a process for obtaining a set of database embeddings, in accordance with an example embodiment.

FIG. 21 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Query Generation

Embodiments of the present disclosure relate to generation of queries, e.g., query language queries (e.g., Kusto Query Language (KQL) queries, structured query language (SQL) queries, etc.). A query language query (also referred to as a “QL query” herein) is used to perform database operations, such as, but not limited to, retrieving and/or transforming records in a database. For instance, an application (or a user utilizing an application or computing device) in an example implementation provides a QL query to be executed against a database to retrieve and manipulate data in the database. In accordance with an embodiment, a QL query relies on knowledge of the query language and knowledge of the database being queried. In some implementations of query generation, a natural language to query language engine (also referred to as a “language conversion engine” herein) is utilized to facilitate generation of QL queries to execute against a database. For instance, a user or application provides a query in natural language (i.e., language of ordinary speaking and/or writing) to the language conversion engine. The language conversion engine converts the provided query (also referred to as a “natural language query” or “NL query” herein) to a QL query suitable for execution against a database. In this manner, the language conversion engine simplifies interaction between a user or application desiring to access or manipulate data in a database and the database.

Embodiments of the present disclosure leverage a generative artificial intelligence (AI) model to convert NL queries to QL queries. A generative AI model is a model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. In examples, a token is a word, a character (e.g., an alphanumeric character, a blank space, a symbol, etc.), or a sub-word (e.g., a root word, a prefix, or a suffix). In other types of models (e.g., image based models) a token represents another kind of atomic unit (e.g., a subset of an image).

A large language model (LLM) is a language model that has a high number of model parameters. For instance, in examples, an LLM has millions, billions, trillions, or even greater numbers of model parameters. Model parameters of an LLM are the weights and biases the model learns during training. An LLM is (pre-) trained using self-supervised learning and/or semi-supervised learning. In examples, an LLM is trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from system, and/or the like. Furthermore, an LLM in an example implementation is fine-tuned using Reinforcement Learning with Human Feedback (RLHF), where the LLM is provided the same input twice and provides two different outputs and a user ranks which output is preferred. In this context, the user's ranking is utilized to improve the model. In examples, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

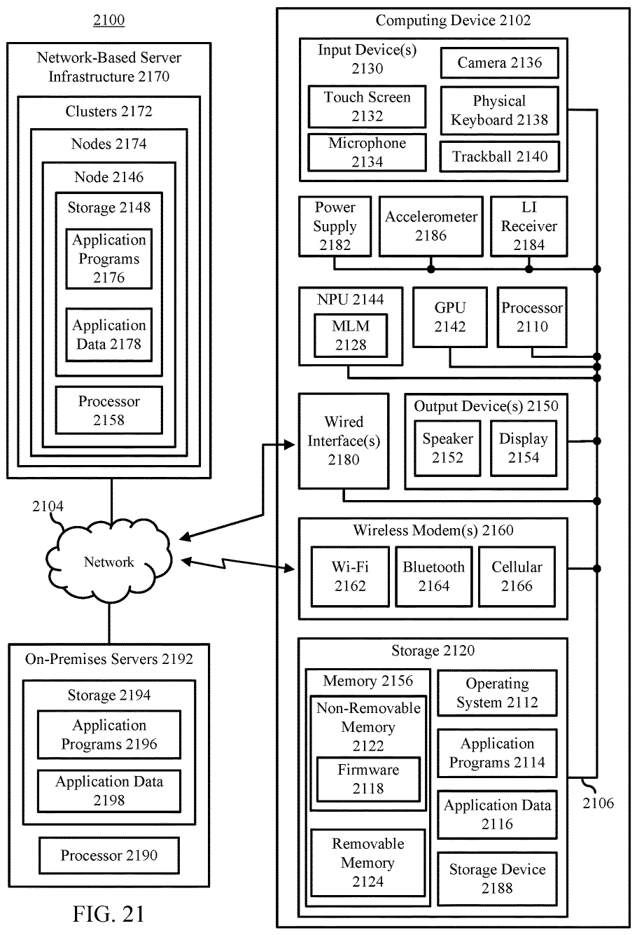

Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks). Additional details regarding transformer-based LLMs are described with respect to FIG. 21, as well as elsewhere herein.

As mentioned above, QL queries rely on knowledge of the query language and knowledge of the database to perform a database operation. In some implementations, a generative AI, such as an LLM, has parametric knowledge of the query language (e.g., from an original data source or from fine-tuning). However, knowledge of the database to be queried typically requires more specialized knowledge obtained through experience or experimentation. Generative AI alone may require a user to impart knowledge for specific values within a database to reduce the rate of hallucination (i.e., generation of incorrect or misleading results) when converting an NL query to a QL query. This requires additional input and time from the user or application providing the NL query, in particular for queries made with respect to large databases.

In an aspect of the present disclosure, methods, systems, and computer-readable storage media described herein instill a generative AI model with additional insight to assist the model in converting a NL query to a QL query. For example, in an embodiment, a request associated with querying a database is received. A request embedding is determined based on the request. A request embedding describes a context of the request (e.g., textually, or semantically). For instance, the request embedding in accordance with a particular embodiment is determined utilizing an embedding model configured to determine embeddings based on input. The request embedding is compared to layer embeddings of a deep data map to determine a similarity between the request embedding and one or more of the layer embeddings. A deep data map comprises tiers of layer embeddings that provide accurate and relevant context regarding data in a database. In particular, each layer embedding describes a context of a particular item within a layer of a database (e.g., a cluster, a table, a column, a value, etc.). In examples, a deep data map comprises any number of tiers of layer embeddings, including, but not limited to, database embeddings that describe a context of the database, cluster embeddings that describe a context of a corresponding cluster in the database, table embeddings that describe a context of a corresponding table in the database, column embeddings that describe a context of a corresponding column in a table of the database, value embeddings that describe a context of a corresponding value in a column of a table of the database. Ranked items are determined based on layer embeddings that are similar to the request embeddings and descriptions of ranked items are included in a prompt to the generative AI model to generate a QL query. For example, in embodiments, embeddings such as request embeddings, database embeddings, cluster embeddings, table embeddings, column embeddings, and value embeddings are represented as vectors of floating-point numbers such that the distance between two embeddings in vector space is correlated with semantic similarity between two inputs in their original format. In this context, embodiments leveraging a deep data map improve the generation of QL queries based on natural language input by adding additional insight and/or context to the query and portions of the database being query, thereby conserving resources (as less input is needed from the requesting application or user), reducing the probability of hallucination (thereby reducing time needed to repair and/or otherwise post-process a query), increase the quality of a generated QL query, and decreasing the time to generate a valid query.

Techniques leveraging a generative AI model may experience “hallucination” where the generative AI model generates incorrect or misleading results. Some implementations of query generation utilizing generative AI employ validation techniques to determine if a QL query generated by an AI model is valid. If the response is invalid, a mitigation technique can be used to address the issue. For instance, an error can be reported to the user or application (e.g., the “calling service”) that transmitted the request for generation of the QL query. However, this can take additional time for the user or application to address the error (e.g., by manually generating the query, manually revising the generated query, or by making a new request to the language conversion engine). Alternatively, a new prompt can be transmitted to the generative AI model, either with or without additional context (e.g., an indication that the previously generated QL query is invalid). However, the generative AI model can take a (e.g., relatively) long time to generate a prompt and can utilize a large amount of compute resources. Furthermore, if the generative AI model hallucinates again, the model will have to be re-prompted, further expending resources and time.

In another aspect of the present disclosure, methods, systems, and computer readable storage medium described herein provide techniques for repairing invalid QL queries generated by a generative AI model. For example, in an embodiment, an alert indicating a variable of a QL query generated by a generative AI model, such as an LLM, is undefined is received. Examples of a variable of a database include, but are not limited to, an identifier of a database, an identifier of a cluster of the database, a name of a table of the database, a name of a column of data of the database, a value stored in the database, and/or the like. The QL query corresponds to a prompt previously provided to the generative AI model. A query embedding associated with the QL query and corresponding to the undefined variable is received. Example query embeddings include, but are not limited to, database embeddings, cluster embeddings, table embeddings, column embeddings, value embeddings, and/or the like. In an implementation, the query embedding describes a context of the undefined variable. The query embedding is compared to a set of database embeddings to determine a candidate variable. The candidate variable is associated with a database embedding of the set of embeddings wherein a similarity between the query embedding and the database embedding satisfies similarity criteria. In an embodiment, similarity criteria specifies a threshold to be satisfied by a measure of similarity between embeddings. In an alternative embodiment, another type of similarity criteria is used, as would be understood by a person ordinarily skilled in the relevant art(s) having benefit of the present disclosure. Example measures of similarity include, but are not limited to, Euclidean distance similarity, cosine similarity, dot product similarity, and/or any other technique suitable for measuring similarity between embeddings. In embodiments of the described aspect, the candidate variable is substituted in for the undefined variable in the QL query to generate a repaired QL query and a response comprising the repaired QL query is generated. In a further aspect, the response is returned as a response of the generative AI model (i.e., on behalf of the generative AI model). Embodiments leveraging embeddings to repair an invalid QL query enable query repair without requiring a re-call of the generative AI model, thereby reducing the time taken and compute resources used to resolve invalid queries. For instance, in a non-limiting implementation, a query repair process utilizing the embeddings as described herein repairs an invalid QL query in a matter of milliseconds. In contrast, a non-limiting implementation of query repair utilizing a generative AI model to re-generate the QL query takes several seconds (e.g., ten seconds, twenty seconds, and/or the like).

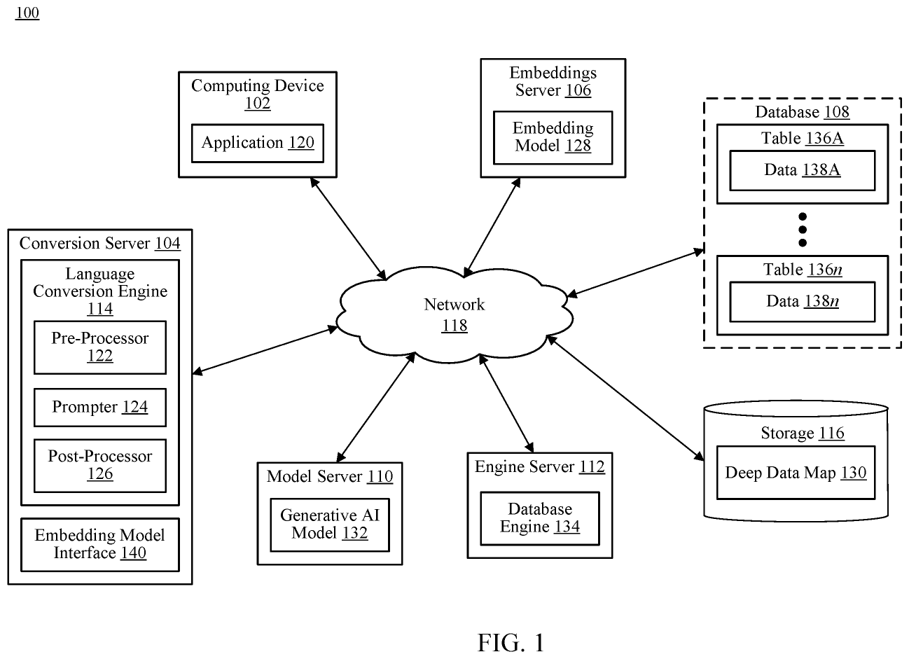

In examples, systems, devices, and apparatuses are configured in various ways for generating database queries based on natural language. For example, FIG. 1 shows a block diagram of a system 100 for query generation, in accordance with an example embodiment. System 100 comprises a computing device 102, a conversion server 104, an embeddings server 106, a database 108, a model server 110, an engine server 112, and a storage 116. Computing device 102, conversion server 104, embeddings server 106, database 108, model server 110, engine server 112, and storage 116 are communicatively coupled via a network 118. In examples, network 118 comprises one or more networks such as local area networks (LANs), wide area networks (WANs), enterprise networks, the Internet, etc. In examples, network 118 comprises one or more wired and/or wireless portions. The features of system 100 are described in detail as follows.

Database 108 is configured to store data. Examples of database 108 include, but are not limited to unstructured databases (e.g., binary large object (blob) storages), structured databases (e.g., SQL databases), and semi-structured database. In implementations, database 108 includes any amount of data organized in various ways. For instance, as shown in FIG. 1, database 108 comprises tables 136A-136n storing respective sets of data 138A-138n. Each table of tables 136A-136n comprise one or more columns in which respective data of data 138A-138n is organized. In accordance with an embodiment, tables of tables 136A-136n are grouped into “clusters” (not shown in FIG. 1 for brevity). In accordance with an embodiment, database 108 implemented as a cloud-based storage (e.g., cloud-based data lake storage, cloud-based file system, cloud-based database, etc.). In this context, database 108 is stored by one or more servers in a networked-server infrastructure (not shown in FIG. 1 for brevity).

Storage 116 stores data used by and/or generated by computing device 102, conversion server 104, embeddings server 106, model server 110, engine server 112, and/or components thereof and/or services executing thereon. For instance, as shown in FIG. 1, storage 116 stores a deep data map 130. Deep data map 130 comprises tiers of layer embeddings that provide accurate and relevant context regarding data in database 108. In particular, each layer embedding describes context of a particular item within a layer of database 108 (e.g., a cluster, a table, a column, a value, etc.). In examples, deep data map 130 comprises any number of tiers of layer embeddings, including, but not limited to, database embeddings, cluster embeddings, table embeddings, column embeddings, value embeddings and/or any other tiers of embeddings that describe context of items within a layer of database 108.

As shown in FIG. 1, storage 116 is external to computing device 102, conversion server 104, embeddings server 106, database 108, model server 110, and engine server 112. In an alternative example embodiment, all or a portion of storage 116 is internal to computing device 102, conversion server 104, embeddings server 106, database 108, model server 110, and/or engine server 112. In accordance with an embodiment, storage 116 is a remote storage accessible over network 118 (e.g., a web storage, a blob storage, a networked file system, a cloud storage, etc.).

In examples, computing device 102 is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a user (e.g., an individual user, a group of users, an organization, a family user, a customer user, an employee user, an admin user (e.g., a service team user, a developer user, a management user, etc.), etc.). Computing device 102 is configured to execute an application 120. In accordance with an embodiment, application 120 enables a user to interface with conversion server 104, embeddings server 106, database 108, model server 110, engine server 112, and/or storage 116.

Conversion server 104, embeddings server 106, model server 110, and engine server 112 are network-accessible servers (or other types of computing devices). In accordance with an embodiment, one or more of conversion server 104, embeddings server 106, model server 110, and engine server 112 are incorporated in a network-accessible server set (e.g., a cloud-based environment, an enterprise network server set, and/or the like). Furthermore, as shown in FIG. 1, each of conversion server 104, embeddings server 106, model server 110, and engine server 112 are a single server or other computing device. In an alternative example embodiment, any of conversion server 104, embeddings server 106, model server 110, and engine server 112 are implemented across multiple servers or computing devices (e.g., as a distributed service). Each of conversion server 104, embeddings server 106, model server 110, and engine server 112 are configured to execute services and/or store data. For instance, as shown in FIG. 1, conversion server 104 is configured to execute a language conversion engine 114 and an embedding model interface 140, embeddings server 106 is configured to execute an embeddings model 128, model server 110 is configured to execute a generative AI model 132, and engine server 112 is configured to execute a database engine 134. In accordance with an embodiment, application 120 interfaces with language conversion engine 114, embedding model 128, generative AI model 132, and/or database engine 134 over network 118.

Application 120 comprises an application configured to utilize language conversion engine 114 to generate a query language query and cause the execution of QL queries against database 108. For example, application 110 in accordance with an embodiment is an application for analyzing cyberthreats, benchmark testing data, analyzing customer data, and/or any other type of application suitable for causing queries to be executed against database 108. Application 120 in accordance with an embodiment sends a request to query a database to language conversion engine 114 to cause generation of a QL query. In accordance with an embodiment, the request comprises a NL query. In examples, an NL query takes form of a question, a request, or some other form of natural language input that causes language conversion engine 114 to generate a QL query, as described elsewhere herein. In accordance with an embodiment, application 120 receives QL queries generated by language conversion engine 114 and transmits them to database engine 134 for execution thereof. Alternatively, QL queries generated by language conversion engine 114 are provided to database engine 134 automatically.

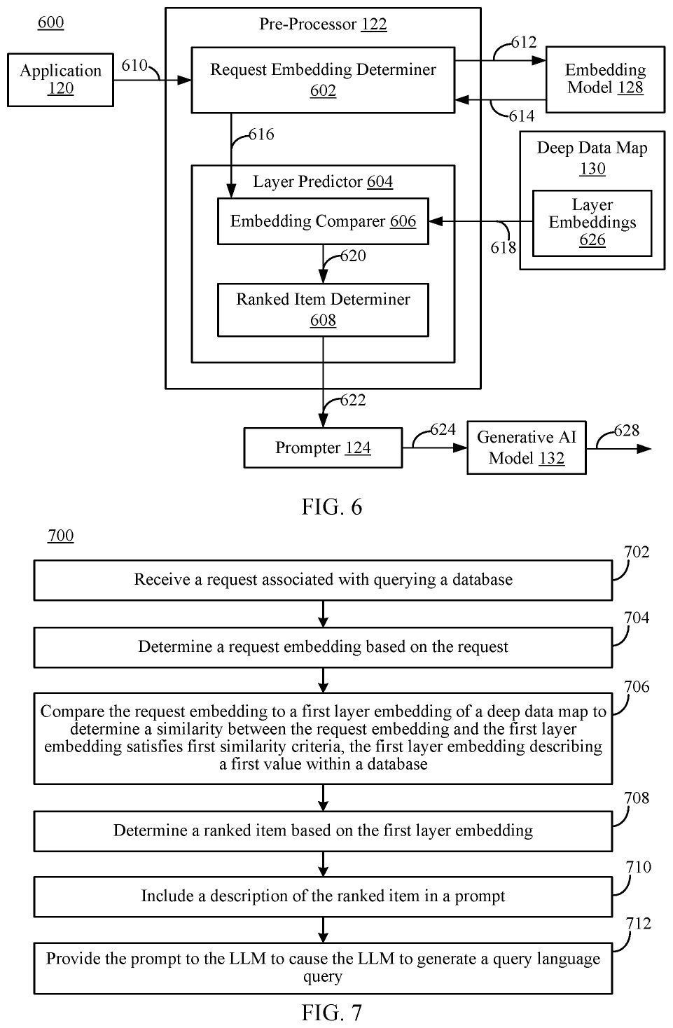

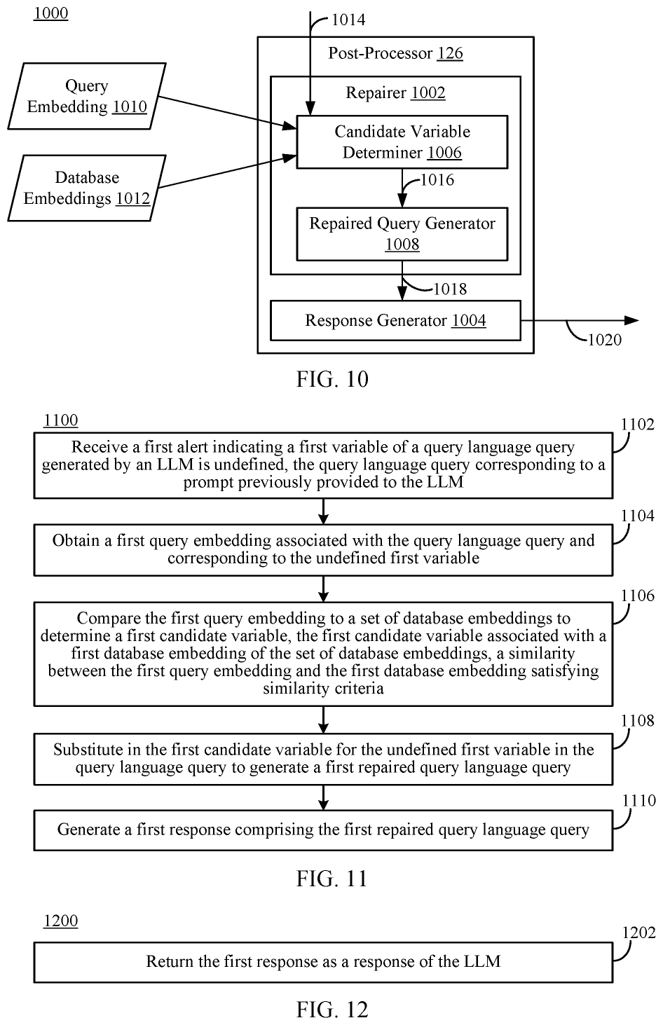

Embedding model 128 is a model configured to generate embeddings for use in machine learning. The embeddings generated by embedding model 128 are information dense representations of semantic meaning of an input (e.g., a piece of text). For instance, in accordance with an embodiment, an embedding is a vector of floating-point numbers such that the distance between two embeddings in vector space is correlated with semantic similarity between two inputs in their original format (e.g., text format). As an example, if two texts are similar, their vector representations should also be similar. In this manner, embeddings generated by embedding model 128 provide representation of data usable by systems described herein for performing various functions associated with data represented by embeddings. For instance, pre-processor 122 utilizes embeddings to improve prompt generation (e.g., as described with respect to FIGS. 6-9, as well as elsewhere herein). In another aspect, post-processor 126 utilizes embeddings to repair a query (e.g., as described with respect to FIGS. 10-14 and 16-20).

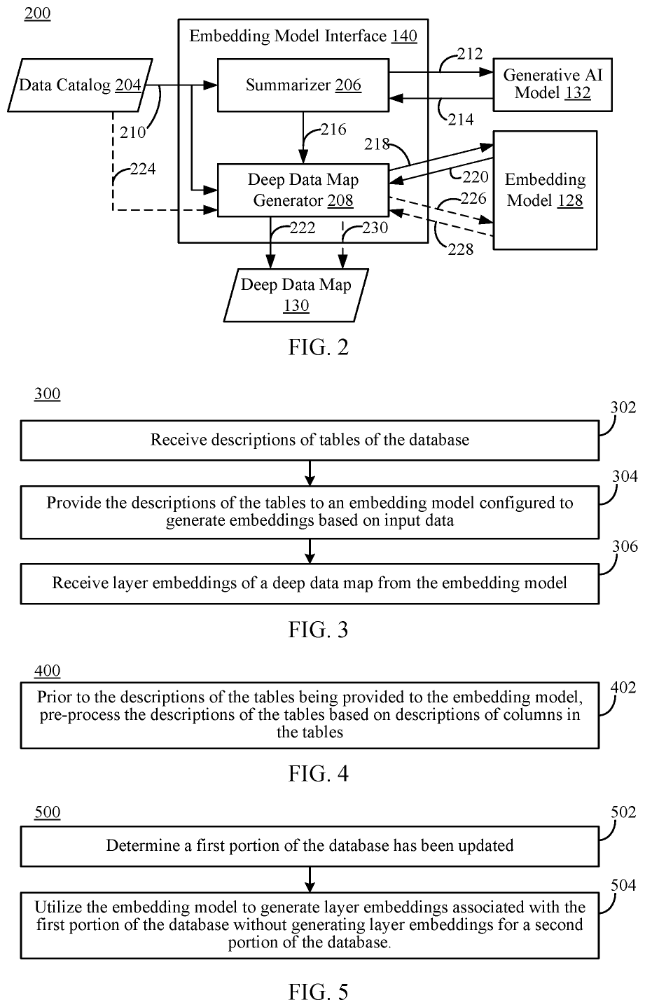

Embedding model interface 140 is configured to utilize embedding model 128 to generate embeddings and deep data maps (e.g., deep data map 130). For instance, in accordance with an embodiment described further with respect to FIGS. 2-5 (as well as elsewhere herein), embedding model interface 140 utilizes embedding model 128 to generate embeddings stored as a deep data map (e.g., deep data map 130). As shown in FIG. 1, embedding model interface 140 is a service executed by conversion server 104. Alternatively, embedding model interface 140 is executed by a different server (e.g., embeddings server 106, another server of system 100, or a server not shown in FIG. 1 for brevity (e.g., a deep data map generation server). In another alternative embodiment, embedding model interface 140 is implemented as an application executed by computing device 102 (e.g., application 120 or another application not shown in FIG. 1).

Language conversion engine 114 is configured to convert natural language input (e.g., an NL query) to a QL query. As shown in FIG. 1, language conversion engine 114 is a service executed by conversion server 104. Alternatively, one or more components of language conversion engine 114 are implemented by application 120 (or another application executing on computing device 102 not shown in FIG. 1 for brevity). As shown in FIG. 1, language conversion engine 114 includes a pre-processor 122, a prompter 124, and a post-processor 126. Pre-processor 122 comprises logic for receiving requests to generate QL queries, refining schema, generating request embeddings, determining additional context to include in a prompt to generative AI model 132, and/or performing any other operations with respect to pre-processing information for use in generating a prompt to generative AI model 132 to cause generative AI model 132 to generate a QL query. In accordance with an embodiment, pre-processor 122 comprises an interface for communicating with embedding model 128 via network 118. Additional details regarding pre-processor 122 are described with respect to FIGS. 6-9, as well as elsewhere herein.

Prompter 124 comprises logic for providing a prompt to generative AI model 132 to cause the generative AI model 132 to generate a QL query. In accordance with an embodiment, prompter 124 provides the prompt to generative AI model 132 as an application programming interface (API) call of generative AI model 132. In accordance with an embodiment, prompter 124 includes an interface for communicating with generative AI model 132 via network 118. Additional details regarding prompter 124 are described with respect to FIGS. 6 and 7, as well as elsewhere herein.

Post-processor 126 comprises logic for parsing QL queries, repairing QL queries, providing responses on behalf of generative AI models, causing execution of QL queries (e.g., by providing a QL query to database engine 134), and/or performing any other operations with respect to post-processing QL queries generated by generative AI model 132. In accordance with an embodiment, post-processor 126 comprises respective interfaces for communicating with embedding model 128, generative AI model 132, and/or database engine 134 via network 118. Additional details regarding post-processor 126 are described with respect to FIGS. 10-20, as well as elsewhere herein.

Generative AI model 132 is configured to generate QL queries based on a received prompt. In examples, generative AI model 132 is any type of generative AI model capable of generating QL queries based on prompts received from prompter 124. In accordance with an embodiment, generative AI model 132 is an LLM. In an example, generative AI model 132 is trained using public information (e.g., information collected and/or scrubbed from the Internet) and/or data stored by an administrator of model server 110 (e.g., stored in memory of model server 110 and/or memory accessible to model server 110. In accordance with an embodiment, generative AI model 132 is an “off the shelf”′ model trained to generate complex, coherent, and/or original content based on (e.g., any) prompts. In an alternative embodiment, generative AI model 132 is a specialized model trained to generate QL queries based on prompts. Additional details regarding the operation and training of generative AI models such as generative AI model 132 are described in Section VI of the present disclosure, as well as elsewhere herein.

Database engine 134 is configured to execute queries against a database (e.g., database 108) to generate query results. In some embodiments, database engine 134 implements query optimization techniques. As shown in FIG. 1, database engine 134 is executed by engine server 112. Alternatively, database engine 134 is implemented by an application executed by computing device 102 (e.g., application 120). In another alternative embodiment, database engine 134 is implemented as a component of language conversion engine 114 (e.g., as a sub-component of post-processor 126 or as a separate component of language conversion engine 114).

Thus, system 100 has been described with respect to generating QL queries and executing the queries against a database. Additional details regarding prompting a generative AI model, post-processing queries, and generating deep data maps are described in the following sections (as well as elsewhere herein).

### III. Embodiments for Deep Data Map Generation

As described herein, embodiments of query generation described herein utilize embeddings of a database to pre-process prompts to a generative AI model and/or repair QL queries generated by the generative AI model. In some implementations, embodiments leverage deep data map 130 of FIG. 1 to perform respective operations. Deep data map 130 comprises tiers of layer embeddings that provide accurate and relevant context regarding data in database 108. In examples, embedding model interface 140 utilizes embedding model 128 (and/or generative AI model 132) to generate deep data map 130 in various ways, in embodiments. For example, FIG. 2 shows a block diagram of a system 200 for generating a deep data map, in accordance with an example embodiment. As shown in FIG. 2, system 200 comprises embedding model 128, deep data map 130, generative AI model 132, and embedding model interface 140 as described with respect to FIG. 1, and a data catalog 204. As also shown in FIG. 2, embedding model interface 140 comprises a summarizer 206 and a deep data map generator 208. In examples, summarizer 206 and deep data map generator 208 are implemented as sub-services of embedding model interface 140.

Data catalog 204 comprises descriptions of database 108 and its layers (e.g., clusters, tables, columns, values, etc.). In some embodiments, data catalog 204 comprises other schema information of database 108, such as column types. In examples, data catalog 204 is a “source” of descriptions of database 108. Examples of data catalog 204 include, but are not limited to, product documentation (e.g., a product catalog, a data sheet, an index, etc.), usage data of an application, a data contract, stored data of database 108, code related to database 108, and/or other sources suitable for determining descriptions of database 108, as described elsewhere herein and/or as would otherwise be understood by a person ordinarily skilled in the relevant art(s) having benefit of this disclosure. In accordance with an embodiment, data catalog 204 is a single source of descriptions of database 108. In accordance with another embodiment, data catalog 204 comprises multiple sources of descriptions of database 108. For instance, in a non-limiting example, table descriptions and column descriptions are obtained from product documentation regarding database 108 and value descriptions are obtained from usage data by applications and/or users interacting with database 108.

As stated above, embedding model interface 140 is configured to utilize embedding model 128 to generate deep data map 130. To better understand the operation of embedding model interface 140, FIG. 2 is described with respect to FIG. 3. FIG. 3 shows a flowchart 300 of a process for generating a deep data map, in accordance with an example embodiment. In accordance with an embodiment, embedding model 128 of FIG. 2 operates according to flowchart 300. Not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, descriptions of tables of the database are received. For example, deep data map generator 208 of FIG. 2 receives descriptions 210 from data catalog 204 and descriptions 216 from summarizer 206. In examples, descriptions 210 comprises descriptions of values, columns, tables, clusters, and/or any other tiers of database 108. In examples, and as further described with respect to FIG. 4 (as well as elsewhere herein), descriptions 216 comprises descriptions of tables of database 108 generated utilizing a generative AI model (e.g., generative AI model 132, as shown in FIG. 2, or another generative AI model not shown for brevity). Alternatively, or additionally, descriptions 216 comprise descriptions of other tiers of database 108 generated utilizing a generative AI model. While deep data map generator 208 is depicted in FIG. 2 as receiving descriptions from both data catalog 204 and summarizer 206, in an alternative embodiment, deep data map generator 208 receives descriptions from data catalog 204 (i.e., and not summarizer 206). In another alternative embodiment, deep data map generator 208 receives descriptions from summarizer 206 (i.e., and not data catalog 204).

In step 304, the descriptions of the tables are provided to an embedding model configured to generate embeddings based on input data. For example, deep data map generator 208 of FIG. 2 provides an embedding request 218 to embedding model 128. Embedding request 218 comprises descriptions of tables (and/or other tiers of database 108) received in step 302. In accordance with an embodiment, embedding request 218 is a single request comprising descriptions for each tier of database 108 that embedding model 128 is to generate embeddings for. In an alternative embodiment, deep data map generator 208 transmits embedding request 218 to embedding model 128 as multiple requests (e.g., a series of requests to generate embeddings for different tiers of database 108 (e.g., a first request to generate table embeddings, a second request to generate column embeddings, a third request to generate value embeddings, etc.)). In accordance with an embodiment, and as further described with respect to FIG. 4 (as well as elsewhere herein), embedding model interface 140 (or a component thereof, e.g., summarizer 206) leverages a generative AI model (e.g., generative AI model 132) to generate extended summaries for a tier of database 108 (e.g., a table).

In some embodiments, embedding request 218 comprises additional information for a particular tier. For instance, as a non-limiting example, an implementation of embedding request 218 for determining table embeddings for a table comprises a table name, a table description, and (e.g., optionally) table schema (e.g., column information, value information, and/or other table schema). In this manner, a comprehensive input is provided to embedding model 128 to mitigate potential ambiguity and vagueness when relying solely on table names. As another example, an implementation of embedding request 218 for determining column embeddings for a column comprises a table name, a column name, a column type, and a column description. In this manner, a comprehensive input is provided to embedding model 128 to mitigate potential ambiguity or vagueness when relying solely on column names. Thus, the embeddings generated by embedding model 128 are improved through provision of additional input for a particular tier. As another example, suppose values on their own lack clarity. In this context, embedding request 218 for determining value embeddings for a value comprises a table name, a column name, the value, and (e.g., optionally) a value description. In this manner, the accuracy of value embeddings is increased through the provision of additional context. This additional information may be particularly relevant when dealing with columns that relate to numbers/codes or codewords representative of further details. For instance, in a non-limiting security implementation, an error code on its own is a numeric value (e.g., 16000). However, the description of the error code provides additional contextual information that, when received by embedding model 128, enables embedding model 128 to generate embeddings representative of the error code with improved accuracy.

Embedding model 128 is configured to generate layer embeddings in various ways, in embodiments. In some examples, embedding model 128 generates layer embeddings for layers that have “low cardinality.” For instance, in some examples, embedding model 128 generates column embeddings for columns with “low cardinality.” A column with low cardinality is a column with values from a pre-defined list and/or values that follow a derived format constructed from accessible information. Examples of low cardinality columns include, but are not limited to, a column including products from a list of supported products, an attack technique from a list of known attack techniques, an attack vector from a list of known attack vectors. In some embodiments, a column of database 108 is classified as a “high cardinality” column. Examples of high-cardinality columns include, but are not limited to, columns where values may be any value of an infinite number of (or near infinite number of) options (e.g., date-timestamps) and/or columns where values may be any value of a very large number of finite options (e.g., global universal identifiers (GUIDs), primary keys, etc.). In accordance with an embodiment, embedding model 128 is configured to identify columns that are low cardinality columns from among columns of a table comprising high and low cardinality columns and generate request embeddings for values collected from the identified columns.

In step 306, layer embeddings of a deep data map are received from the embedding model. For example, deep data map generator 208 receives response 220 from embedding model 128 comprising layer embeddings. Embedding model 128 generated the layer embeddings included in response 220 based on descriptions included in embedding request 218. In accordance with an embodiment, response 220 is a single response comprising layer embeddings for each tier of database 108. Alternatively, response 220 is multiple responses comprising layer embeddings for different tiers of database 108. In accordance with an embodiment, and as shown in FIG. 2, deep data map generator 208 is configured to generate deep data map 130 from layer embeddings included in response 220. Alternatively, response 220 comprises deep data map 130 generated by embedding model 128. In accordance with an embodiment, deep data map generator 208 stores deep data map 130 in storage accessible to language conversion engine 114 of FIG. 1 (e.g., storage 116). By generating deep data map 130 “offline” (e.g., separate from runtime of QL query generation), embodiments of embedding model interface 140 reduce time spent and compute resources utilized during QL query generation runtime. For instance, in this context, embedding model 128 is only called to generate an embedding for a portion of database 108 during initial generation of deep data map 130 and when that particular portion of database 108 is updated, as opposed to language conversion engine 114 having to place a call to embedding model 128 each time a request to generate a QL query is received. This reduces redundant expenditure of compute resources. Furthermore, since deep data map 130 is generated offline, the time spent to generate a QL query during runtime is reduced (as further described with respect to FIGS. 6 and 7, as well as elsewhere herein).

In some embodiments, and as shown in FIG. 2, embedding model interface 140 is configured to leverage a generative AI model (e.g., generative AI model 132) to generate descriptions of one or more tiers of database 108. For instance, in accordance with an embodiment, embedding model interface 140 leverages generative AI model 132 to generate descriptions of tables of database 108. To better understand this example, system 200 of FIG. 2 is described with respect to FIG. 4. FIG. 4 shows a flowchart 400 of a process for pre-processing descriptions, in accordance with an example embodiment. In accordance with an embodiment, embedding model 128 of FIG. 2 operates according to flowchart 400. Flowchart 400 need not be performed in all embodiments. Further structural and operational embodiments will be apparent to persons skilled in the relevant art(s) based on the following description of FIG. 4 with respect to FIG. 2.

Flowchart 400 includes step 402. In step 402, prior to the description of the tables being provided to the embedding model, the descriptions of the tables are pre-processed based on descriptions of columns in the tables. For example, summarizer 206 of FIG. 2 pre-processes descriptions of tables of database 108 based on descriptions of columns in the tables. For instance, summarizer 206 receives descriptions 210 from internal and/or external data sources. As shown in FIG. 2, summarizer 206 receives descriptions 210 from data catalog 204. In this context, descriptions 210 comprise descriptions of columns in the tables (e.g., information regarding columns (e.g., column names, column content descriptions, values in the columns, descriptions of the values, and/or the like)) and/or information regarding tables (e.g., table names, table descriptions, table schema, and/or the like) of database 108. Summarizer 206 generates a prompt 212 to cause generative AI model 132 to generate refined descriptions of the tables based on the provided descriptions 210 and provides prompt 212 to generative AI model 132. Generative AI model 132 infers deeper descriptions of tables based on descriptions included in prompt 212. Summarizer 206 receives a response 214 comprising the refined descriptions generated by generative AI model 132 and provides the descriptions to deep data map generator 208 as descriptions 216, and flow continues to step 302 as described with respect to flowchart 300 of FIG. 3. In this context, summarizer 206 leverages generative AI model 132 to generate descriptions of tables that have a more detailed description than the descriptions included in data catalog 204. For instance, as a non-limiting example, generative AI model 132 generates a description for a table that encompasses (e.g., all) columns within the table without listing out each column (e.g., this table is a for security alerts in a particular service product and contains information regarding the variety of security alerts and the attack vectors used). In this manner, the refined descriptions improve the quality of table embeddings generated by embedding model 128.

Flowchart 400 of FIG. 4 is described with respect to pre-processing descriptions of tables based on descriptions of columns in the tables. It is also contemplated that, in examples, descriptions of tables are pre-processed based on descriptions of other tiers in a database including, but not limited to, higher tiers (e.g., a description of a cluster comprising the table, a description of the database comprising the table, etc.) and/or other lower tiers (e.g., descriptions of values within columns of the table, etc.). In other examples, summarizer 206 operates in a similar manner to that described with respect to flowchart 400 to pre-process descriptions of other tiers of database 108. For instance, in accordance with an embodiment, summarizer 206 pre-processes descriptions of clusters of database 108 based on descriptions of tables in a similar manner as described with respect to flowchart 400. In this context, summarizer 206 pre-processes descriptions of the clusters based on descriptions of the tables received from data catalog 204 and/or the refined descriptions of the tables received from generative AI model 132.

Depending on the implementation, embodiments of the present disclosure leverage generative AI models that are trained on a general corpus of information (e.g., a general corpus of web content) or a specialized corpus of information (e.g., a corpus related to a particular field, such as security, health, education, or another field). In some implementations where the generative AI model is trained on a general corpus, generative AI model 132 lacks detailed information for a particular field. If data within this particular field is updated or otherwise changes, generative AI model 132 may have difficulty accurately generating QL queries for the field. In some embodiments of the present disclosure, utilizing an embedding model (such as embedding model 128) to generate a deep data map (such as deep data map 130) enables selectively refreshing information that is used to improve prompting to generative AI model 132 utilizing a lighter weight model (e.g., embedding model 128) without having to retrain generative AI model 132. In this context, the quality of natural language to query language query generation by generative AI model 132 is improved with fewer resource expenditure, as retraining a generative AI model can be expensive and time consuming.

Furthermore, in some embodiments, embedding model interface 140 operates to update a portion of deep data map 130 without having to update the entirety of deep data map 130. For example, FIG. 5 shows a flowchart 500 of a process for updating a deep data map, in accordance with an example embodiment. In accordance with an embodiment, embedding model 128 of FIG. 2 operates according to flowchart 500. Not all steps of flowchart 500 need be performed in all embodiments. Further structural and operational embodiments will be apparent to persons skilled in the relevant art(s) based on the following description of FIG. 5 with respect to FIG. 2.

Flowchart 500 begins with step 502. In step 502, a first portion of the database is determined to have been updated. For example, deep data map generator 208 of FIG. 2 receives updated descriptions 224 from data catalog 204 corresponding to a first portion of database 108 being updated. In examples, updated descriptions 224 includes updates to database 108, clusters of database 108, tables of database 108, columns of the tables, and/or values of the tables. In some embodiments, summarizer 206 utilizes generative AI model 132 to generate refined descriptions of one or more descriptions of descriptions 224 in a similar manner to that described with respect to flowchart 400 of FIG. 4.

In step 504, the embedding model is utilized to generate layer embeddings associated with the first portion of the database without generating layer embeddings for a second portion of the database. For example, deep data map generator 208 of FIG. 2 utilizes embedding model 128 to generate layer embeddings associated with the first portion of database 108 without generating layer embeddings for a second portion of database 108. As shown in FIG. 2, deep data map generator 208 provides a request 226 to embedding model 128. Request 226 comprises descriptions included in updated descriptions 224 (and, optionally, refined descriptions of updated descriptions 224 generated by summarizer 206 utilizing generative AI model 132). Embedding model 128 provides a response 228 comprising layer embeddings associated with the first portion of database 108 to deep data map generator 208. Deep data map generator 208 utilizes the layer embeddings to update deep data map 130 via signal 230. For instance, in accordance with an embodiment, deep data map 208 provides signal 230 to a storage (e.g., storage 116 of FIG. 1) to cause the storage to update a portion of deep data map 130 to include the layer embeddings provided from embedding model 128 in response 128 (and optionally delete or otherwise remove layer embeddings rendered obsolete or otherwise overwritten by the layer embeddings provided n signal 230). In this context, embedding model interface 140 selectively updates portions of deep data map 130 based on changes to database 108 without having to update the entirety of deep data map 130, thereby reducing resources expended in maintaining an up-to-date deep data map of embeddings describing database 108.

### IV. Embodiments for Prompting a Generative AI Model to Generate a QL Query

As described herein, some embodiments of query generation utilize embeddings of a database to pre-process prompts to a generative AI model. For example, pre-processor 122 of FIG. 1 in accordance with an embodiment utilizes embeddings of deep data map 130 to pre-process input of prompter 124 to cause prompter 124 to prompt generative AI model 132 to generate a QL query. In examples, pre-processor 122 and prompter 124 are configured to pre-process and provide prompts in various ways. For example, FIG. 6 shows a block diagram of a system 600 for prompting a generative AI model to generate a QL query, in accordance with another example embodiment. As shown in FIG. 6, system 600 comprises application 120, pre-processor 122, prompter 124, embedding model 128, deep data map 130, and generative AI model 132, as described with respect to FIG. 1. As also shown in FIG. 6, pre-processor 122 comprises a request embedding determiner 602 and a layer predictor 604. In an example embodiment, request embedding determiner 602 and layer predictor 604 are implemented as sub-services/sub-components of pre-processor 122. Request embedding determiner 602 is configured to determine embeddings of a received request (e.g., by utilizing embedding model 128). Layer predictor 604 is configured to determine ranked items based on request embeddings and deep data map 130. As shown in FIG. 6, layer predictor 604 comprises an embedding comparer 606 and a ranked item determiner 608, each of which are sub-components/sub-services of layer predictor 604. Embedding comparer 606 is configured to compare request embeddings and embeddings of deep data map 130 and ranked item determiner 608 is configured to determine ranked items based on comparisons made by embedding comparer 606.

As further shown in FIG. 6, deep data map 130 comprises layer embeddings 626. Layer embeddings 626 comprise any number of embeddings describing values within database 108. In accordance with an embodiment, embeddings of layer embeddings 626 are arranged in hierarchical tiers. For instance, in a non-limiting example, layer embeddings 626 comprises database embeddings, cluster embeddings dependent on respective database embeddings, table embeddings dependent on respective cluster embeddings, column embeddings dependent on respective table embeddings, and variable embeddings dependent on respective column embeddings.

To better understand the operation of system 600, FIG. 6 is described with respect to FIG. 7. FIG. 7 shows a flowchart 700 of a process for prompting a generative AI model to generate a QL query, in accordance with an example embodiment. In accordance with an embodiment, system 600 of FIG. 6 operates according to flowchart 700. Not all steps of flowchart 700 need be performed in all embodiments. Further structural and operational embodiments will be apparent to persons skilled in the relevant art(s) based on the following descriptions of FIGS. 6 and 7.

Flowchart 700 begins with step 702. In step 702, a request associated with querying a database is received. For example, request embedding determiner 602 of FIG. 6 receives a request 610 associated with querying database 108 of FIG. 1 from application 120. In accordance with an embodiment, request 602 comprises natural language input requesting a query be executed against database 108 to perform a database operation. In accordance with a further embodiment, the natural language input is a natural language query. In examples, request 610 specifies a subset of database 108 (e.g., a table, a cluster, a column within a table, etc.).

In step 704, a request embedding is determined based on the request. For example, request embedding determiner 602 of FIG. 6 utilizes embedding model 128 to determine a request embedding based on request 610. As shown in FIG. 6, request embedding determiner 602 provides an embedding request 612 to embedding model 128 to cause embedding model 128 to determine one or more embeddings based on request 610. In this context, embedding request 612 comprises the natural language input included in request 610. In examples, embedding model 128 generates one or more request embeddings for request 612 based on an analysis of the grammar of the natural language input, of the syntax of the natural language input, of the concepts of the natural language input, and/or the tone of the natural language input. As shown in FIG. 6, embedding model 128 provides a response 614 to request embedding determiner 602. Response 614 comprises the one or more request embeddings generated by embedding model 128. As also shown in FIG. 6, request embedding determiner 602 receives response 614 and provides the generated request embeddings in a request embedding signal 616 to embedding comparer 606, and flow continues to step 706.

In examples, request embeddings generated by embedding model 128 correspond to portions of database 108. For instance, embedding model 128 in examples generates a request embedding corresponding to a cluster of database 108, a request embedding corresponding to a table of database 108 (e.g., a table of a cluster, a table independent of clusters, etc.), a request embedding corresponding to a column of a table, a request embedding corresponding to a value of a column, and/or the like. In accordance with an embodiment, embedding model 128 generates a request embedding corresponding to a column of database 108 where values of the column are from a pre-defined list. In some examples, and as described elsewhere herein, a column where values are from a pre-defined list is classified as a column with “low cardinality.” As discussed elsewhere herein, another example of a low cardinality column is a column with values that follow a derived format constructed from accessible information.

In step 706, the request embedding is compared to a first layer embedding of a deep data map to determine a similarity between the request embedding and the first layer embedding satisfies first similarity criteria, the first layer embedding describing a value within a database. For example, embedding comparer 606 receives a first layer embedding 618 from layer embeddings 626 and the request embedding(s) generated by embedding model 128 in request embeddings signal 616 from request embedding determiner 602. First layer embedding 618 describes a value within a database (e.g., a value embedding describing a context of the value, a column embedding describing a context of a column of a table that includes the value, a table embedding describing a context of a table that includes the value, a cluster embedding describing a context of a cluster of tables including a table that includes the value, and/or the like). Embedding comparer 606 compares a request embedding of request embeddings signal 616 to first layer embedding 618 to determine a similarity between the request embedding and first layer embedding 618. In embodiments, embedding comparer 606 determines the similarity utilizing a measure of similarity described elsewhere herein. If the similarity between the request embedding and first layer embedding 618 satisfies first similarity criteria (e.g., a level of similarity between the embeddings meets or exceeds a satisfaction threshold), embedding comparer 606 provides a similar embeddings signal 620 comprising first layer embedding 618 to ranked item determiner 608 and flow continues to step 708. Otherwise, embedding comparer 606 obtains or otherwise receives another layer embedding to compare the request embedding to. By utilizing deep data map 130 to obtain layer embeddings 626, embedding comparer 606 leverages predetermined embeddings for database 108 without having to place additional calls to embedding model 128 during runtime, thereby reducing redundancy in use of compute resources (e.g., as embeddings for a particular portion of database 108 are only generated when deep data map 130 is generated and/or updated) and reducing time in generating a prompt to generative AI model 132 (e.g., as placing calls to embedding model 128 takes time).

Embedding comparer 606 is described as performing step 706 by receiving a layer embedding (e.g., first layer embedding 618) and comparing the layer embedding to a request embedding to determine if a similarity satisfies first similarity criteria. In an alternative embodiment, embedding comparer 606 receives a set of layer embeddings from layer embeddings 626 to compare the request embedding to (e.g., all layer embeddings of layer embeddings 626, all layer embeddings for a particular tier of database 108 (e.g., all cluster embeddings of database 108, all table embeddings of a cluster (or all table embeddings of database 108), all column embeddings of a table, all value embeddings of a column, etc.), a subset of layer embeddings 626, a subset of layer embeddings for a particular tier of database 108, layer embeddings for tables (and/or columns and/or values of the tables) the user or application that provided request 610 has access to, etc.). For instance, if the request embedding is a table embedding, embedding comparer 606 in accordance with an embodiment receives table embeddings of layer embeddings 626 to compare to the request embedding. In accordance with another embodiment, embedding comparer 606 searches deep data map 130 for layer embeddings that satisfy the first similarity criteria utilizing the request embedding as an index. In embodiments where embedding comparer 606 determines similarities between the request embedding and multiple layer embeddings, embedding comparer 606 provides similar embeddings signal 620 comprising the multiple layer embeddings to ranked item determiner 608 and flow continues to step 708.

In step 708, a ranked item is determined based on the first layer embedding. For example, ranked item determiner 608 of FIG. 6 determines a ranked item based on one or more layer embeddings included in similar embeddings signal 620 with a similarity to the request embedding that satisfies the first similarity criteria (as determined in step 706) (e.g., first layer embedding 618). A ranked item is a value, a column, a table, a cluster, or another item of database 108 that corresponds to the layer embedding that is similar to the request embedding. In an example, ranked item determiner determines ranked items for each layer embedding included in similar embeddings signal 620. In accordance with an example embodiment, ranked item determiner 608 orders ranked items based on how similar the corresponding layer embedding is to the request embedding of request 610. For instance, as a non-limiting example, suppose four layer embeddings were determined in step 706 to have a similarity to a column request embedding that satisfies similarity criteria. In this non-limiting example, ranked item determiner 608 determines four columns of database 108 corresponding to the layer embeddings and ranks them in order from most similar (i.e., the ranked item with a corresponding layer embedding with a similarity to the request embedding higher than the other layer embeddings) to least similar (i.e., the ranked item with a corresponding layer embedding with a similarity to the request embedding lower than the other layer embeddings).

In step 710, a description of the ranked item is included in a prompt. For example, ranked item determiner 608 of FIG. 6 provides a ranked item signal 622 to prompter 124 to cause prompter 124 to include a description of a ranked item in a prompt 624 to generative AI model 132. Depending on the implementation, ranked item signal 622 comprises a single ranked item or multiple ranked items. For instance, ranked item signal 622 in accordance with an embodiment comprises a ranked item most similar to a request embedding. In this instance, prompter 124 includes a description of the ranked item in prompt 624. In accordance with another embodiment, ranked item signal 622 comprises a set of ranked items similar to a request embedding. In accordance with an embodiment where multiple request embeddings are determined, ranked item signal 622 comprises one or more ranked items for each request embedding. In embodiments wherein ranked item signal 622 comprises more than one ranked item, prompter 124 includes a description of one ranked item (e.g., the ranked item with the highest similarity to the request embedding), descriptions of all ranked items, or descriptions of a subset of the included ranked items (e.g., descriptions of a ranked item with a highest similarity for each request embedding of request 610, descriptions of a ranked item for each tier of database 108 for a request embedding of request 610, etc.). In the context of these example implementations described with respect to step 710, by including the ranked item in a prompt to be provided to generative AI model 132, ranked item determiner 608 causes prompter 124 to provide additional insight to portions of database 108 being queried by the natural language input of request 610, thereby improving quality and accuracy of the QL query generated by generative AI model 132. Furthermore, by including descriptions of ranked items determined from deep data map 130, prompter 124 generates a prompt that causes generative AI model 132 to generate an answer based on knowledge specific to the database without requiring generative AI model 132 to be trained specifically for the database. For instance, in a security implementation, a deep data map detailing embeddings for a database enables prompter 124 to generate a prompt to cause generative AI model 132 to generate a QL query for performing a security related operation with respect to database 108 without requiring generative AI model 132 to be trained specifically to database 108. For instance, deep data map 130, in a security implementation, imparts knowledge regarding the security domain to generative AI model 132 to improve the quality and accuracy of QL queries generated by generative AI model 132.

In step 712, the prompt is provided to the LLM to cause the LLM to generate a query language query. For example, prompter 124 of FIG. 6 provides prompt 624 to generative AI model 132 to cause generative AI model 132 to generate a QL query 626. In this context, prompt 624 comprises the included description(s) of one or more ranked item(s). Thus, generative AI model 132 is provided additional insight to portions of a database to be queried by the generated QL query (e.g., QL query 626), thereby improving the accuracy of query generation by generative AI model 132. In this context, language conversion engines implementing pre-processor 122 and prompter 124, such as language conversion engine 114 of FIG. 1, are able to leverage a generative AI model trained on a large corpus of information (that is not necessarily specific to the field a QL query is to be generated for), while reducing the probability of the generative AI model hallucinating and generating an invalid QL query. Furthermore, requests provided to the language conversion engine 114 may be relatively simple requests made in a natural language, as the additional context is determined automatically through the use of embedding model 128 and/or deep data map 130, thereby reducing the resources and time expended by application 120 (and/or a user utilizing application 120) in generating a request.

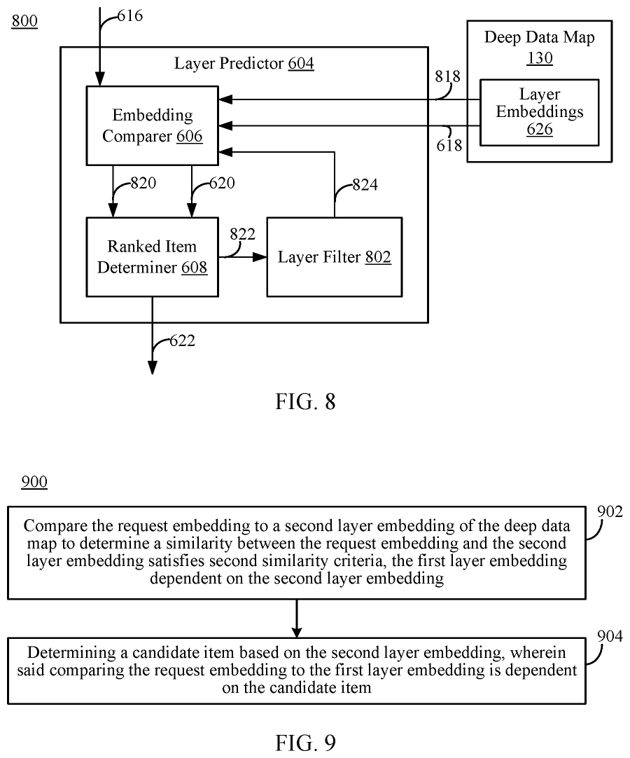

As described herein, layer predictor 604 of FIG. 6 is configured to determine ranked items. Ranked items are utilized to add additional context to a prompt provided to generative AI model 132 to cause generative AI model 132 to generate a QL query. In some embodiments, layer predictor 604 iterates through tiers of layer embeddings to determine ranked items. In examples, layer predictor 604 is configured in various ways to iterate through tiers of layer embeddings to determine ranked items. For example, FIG. 8 shows a block diagram of a system 800 for determining a ranked item, in accordance with an example embodiment. As shown in FIG. 8, system 800 comprises layer predictor 604 (comprising embedding comparer 606 and ranked item 608) and deep data map 130 (comprising layer embeddings 626), as described with respect to FIG. 6. As also shown in FIG. 8, layer predictor 604 comprises a layer filter 802. Layer filter 802 is configured to filter layer embeddings based on ranked items determined by ranked item determiner 608.

To better understand the operation of a layer predictor comprising a layer filter, FIG. 8 is described with respect to FIG. 9. FIG. 9 shows a flowchart 900 of a process for determining a candidate item, in accordance with an example embodiment. In accordance with an embodiment, layer predictor 604 of FIG. 8 operates according to flowchart 900. Not all steps of flowchart 900 need be performed in all embodiments. In accordance with an embodiment, one or more steps of flowchart 900 are further embodiments of step 706 of flowchart 700, as described with respect to FIG. 7. Further structural and operational embodiments will be apparent to persons skilled in the relevant art(s) based on the following descriptions of FIGS. 8 and 9.

Flowchart 900 begins with step 902. In step 902, the request embedding is compared to a second layer embedding of the deep data map to determine a similarity between the request embedding and the second layer embedding satisfies second similarity criteria, the first layer embedding dependent on the second layer embedding. For example, embedding comparer 606 of FIG. 8 compares the request embedding included in request embedding signal 616 to a second layer embedding 818 of layer embeddings 626. Second layer embedding 818 is obtained or otherwise received in a similar manner as described with respect to reception of layer embedding 618 in step 706 of flowchart 700 of FIG. 7, in examples. First layer embedding 618 is dependent on the second layer embedding 818. For instance, as a non-limiting example, suppose second layer embedding 818 is a table embedding describing a context of a table of database 108. In this non-limiting example, first layer embedding 618 is a column embedding describing a context of a column of the table described by second layer embedding 818. If a similarity between the request embedding and second layer embedding 818 satisfies second similarity criteria, embedding comparer 606 provides a similar embeddings signal 820 comprising second layer embedding 818 to ranked item determiner 608 and flow continues to step 904. Otherwise, embedding comparer 606 obtains or otherwise receives other layer embeddings to compare the request embedding to, as described with respect to step 706 of flowchart 700.

In step 904, a candidate item is determined based on the second layer embedding, wherein said comparing the request embedding to the first layer embedding is dependent on the candidate item. For example, ranked item determiner 608 determines a candidate item 822 based on second layer embedding 818 (e.g., included in similar embeddings signal 820). As shown in FIG. 8, candidate item 822 is provided to layer filter 802. Layer filter 802 applies a layer filtering signal 824 that causes embedding comparer 606 to receive a layer embedding dependent on candidate item 822 from layer embeddings 626. For instance, with continued reference to the non-limiting example described with respect to step 902, layer filtering signal 824 causes embedding comparer 606 to receive first layer embedding 618 (the column embedding in this example), which is dependent on candidate item 822 (the table corresponding to the table embedding 818 in this example). In an example, embedding comparer 606 searches layer embeddings 626 for layer embeddings dependent on candidate item 822. Alternatively, layer embeddings for a tier of database 108 are provided to embedding comparer 606 and embedding comparer 606 applies a filter based on layer filtering signal 824 to determine which layer embeddings are dependent on candidate item 822. In this context, flow continues to step 706, as described with respect to flowchart 700 of FIG. 7.

In some embodiments, embedding comparer 606 is configured to determine multiple embeddings similar to a request embedding and/or determine (e.g., multiple) embeddings similar to multiple request embeddings. In an example wherein embedding comparer 606 determines multiple embeddings, embedding comparer 606 iterates through tiers of layer embeddings 626 at a time in a manner described with respect to flowchart 900. For instance, suppose database 108 comprises clusters comprising respective tables, and the tables comprise columns comprising respective values. In this context, embedding comparer 606 determines one or more cluster embeddings similar to request embedding(s) of request embedding signal 616 (e.g., in a manner as described with respect to step 902) and determines candidate clusters based on the similar cluster embeddings (e.g., in a manner as described with respect to step 904). Layer predictor 604 reiterates flow of steps 902 by determining which table embeddings that are dependent on the candidate clusters are similar to the request embedding and determining candidate tables based on the similar table embeddings. The process repeats for each layer of layer embeddings 626 (e.g., determining candidate columns dependent on candidate tables, and determining candidate values dependent on candidate columns). In this manner, layer predictor 604 of FIG. 8 causes prompter 124 of FIG. 1 to include descriptions of tiers of ranked items (e.g., descriptions of a cluster with embeddings similar to a request, which tables within the cluster have embeddings similar to the request, which columns within the tables have embeddings similar to the request, and which values within the columns have embeddings similar to the request. This additional tier of descriptions provides additional context that, when included in a prompt to a generative AI model, improves the quality and accuracy of a QL query generated by the generative AI model.

### V. Embodiments for Post-Processing a QL Query

In some implementations of language conversion engines such as language conversion engine 114, post-processing steps are performed to validate and/or repair QL queries generated utilizing generative AI models (e.g., generative AI model 132). For instance, if a QL query generated by generative AI model 132 is determined to be invalid (e.g., because it comprises an undefined variable), implementations of post-processors (e.g., post-processor 126 of FIG. 1) perform various operations to repair the invalid query. In some implementations, post-processor 126 provides the invalid QL query and diagnostic information (e.g., diagnostic information indicating the QL query is invalid, including particular error codes or reasonings for why the QL query is invalid) to generative AI model 132 to cause generative AI model 132 to regenerate the QL query. In an alternative implementation, post-processor 126 utilizes one or more techniques to (e.g., attempt to) repair the invalid QL query without placing an another call to generative AI model 132. These alternative implementations decrease latency in QL query repair by removing the additional call to the model. Furthermore, compute resources expended by such implementations of post-processor 126 to repair the QL query are (e.g., typically) smaller than compute resources expended by generative AI model 132 to generate a new QL query.

In examples wherein post-processor 126 attempts to repair an invalid query, the post-processor employs a recursive query repair strategy to repair undefined variables, fix joint statements, add missing operators, and/or address other syntactic errors. In some of such examples, post-processor 126 implements a rule-based strategy to address (e.g., common) syntactic errors. These rules provide predefined instructions for fixing types of errors, thereby resulting in quick and accurate resolutions of such errors. Examples of such rules include, but are not limited to, adding properly paired parentheses for an operator (e.g., for the “BETWEEN” operator in a KQL query), adding a tabular operator (e.g., adding an “extend” operator in a KQL query), fixing an aggregation function (e.g., adding a “summarize” operator in a KQL query when aggregate functions are used improperly), and/or any other type of pre-defined rule suitable for fixing errors in invalid QL queries. For instance, an example of a substitution rule causes post-processor 126 to exchange a containing table of an invalid QL query with another table encompassing all the queries outlined in the query.

Sometimes rule-based strategies are limited by their scope. For instance, in the substitution rule example, post-processor 126 locates a table based on column names or identifiers. However, this type of search sometimes misses tables that include semantically similar columns or semantically similar tables. Some implementations of post-processor 126 are configured to implement an “embedding-based repair” in a manner that improves QL query repair strategies. For example, an example embodiment of post-processor 126 utilizes embeddings (e.g., embeddings of deep data map 130, or other embeddings described elsewhere herein) to attempt to repair an invalid QL query in various ways. For instance, FIG. 10 shows a block diagram of a system 1000 for repairing a query generated by a generative AI model, in accordance with an example embodiment. As shown in FIG. 10, system 1000 comprises post-processor 126, as described with respect to FIG. 1, a query embedding 1010 and database embeddings 1012. FIG. 10 is described as follows.

Query embedding 1010 provides context for a variable in a QL query generated by a generative AI model and database embeddings 1012 provide context for variables in a database (e.g., database 108). In accordance with an embodiment, query embedding 1010 is an embedding corresponding to a ranked item included in a prompt provided to a generative AI model (e.g., prompt 624 provided to generative AI model 132, as described with respect to FIGS. 6 and 7). In accordance with another embodiment, query embedding 1010 is received from an embedding model (e.g., embedding model 128). For instance, post-processor 126, a component of post-processor 126, or another service not shown in FIG. 10 provides the query generated by generative AI model 132 to embedding model 128, causing embedding model to generate query embeddings describing the query, and receives query embeddings including query embedding 1010. In accordance with an embodiment, query embedding 1010 is an “approximate query embedding.” In examples, post-processor 126, a component thereof, or a component separate from post-processor 126 estimates query embedding 1010 based on items in database schema (e.g., items in data catalog 204 (e.g., items with an identical name, for example, a column in data catalog 204 with the same name as a column referenced in the QL query)), based on embeddings of layer embeddings 626, and/or any other information associated with database 108 of FIG. 1. In accordance with an embodiment, database embeddings 1012 are examples of layer embeddings 626, as described with respect to FIG. 6.

As also shown in FIG. 10, post-processor 126 comprises a repairer 1002 and a response generator 1004. In accordance with an embodiment, repairer 1002 and response generator 1004 are implemented as sub-services/sub-components of post-processor 126. Repairer 1002 comprises a candidate variable determiner 1006 and a repaired query generator 1008. Candidate variable determiner 1006 is configured to determine potential variables for resolving undefined variables in a QL query (also referred to as “candidate variables” herein) and repaired query generator 1008 is configured to generate repaired queries based on determined candidate variables. Response generator 1004 is configured to generate a response comprising a repaired QL query generated by repaired query generator 1008.

To better understand the operation of system 1000, FIG. 10 is described with respect to FIG. 11. FIG. 11 shows a flowchart 1100 of a process for repairing a query generated by a generative AI model, in accordance with an example embodiment. In accordance with an embodiment, system 1000 of FIG. 10 operates according to flowchart 1100. Not all steps of flowchart 1100 need be performed in all embodiments. Further structural and operational embodiments will be apparent to persons skilled in the relevant art(s) based on the following descriptions of FIGS. 10 and 11.

Flowchart 1100 begins with step 1102. In step 1102, a first alert indicating a first variable of a query language query generated by an LLM is undefined is received, the query language query corresponding to a prompt previously provided to the LLM. For example, candidate variable determiner 1006 of FIG. 10 receives a first alert 1014 indicating a first variable of a QL query generated by generative AI model 132 (not shown in FIG. 10) is undefined. The QL query corresponds to a prompt previously provided to generative AI model 132 (e.g., prompt 626 of FIG. 6, or another prompt generated by generative AI model 132). In some examples, the undefined variable corresponds to a name of a cluster of database 108, a name of a table of database 108, a name of a column of data of database 108, or a value stored in database 108.

In step 1104, a first query embedding associated with the query language query and corresponding to the undefined first variable is obtained. For example, candidate variable determiner 1006 of FIG. 10 receives query embedding 1010. Query embedding 1010 is associated with the invalid QL query and corresponds to the undefined first variable. For instance, query embedding 1010 comprises at least one of a cluster embedding described a context of a cluster of database 108, a table embedding describing a context of a table of database 108, a column embedding describing a context of a column in a table of database 108, a value embedding describing a context of a value in a column of a table of database 108, and/or any other type of embedding describing a context of one or more values of database 108, as described elsewhere herein. In accordance with an embodiment, candidate variable determiner 1006 receives query embedding 1010 by providing the undefined variable to embedding model 128. Alternatively, query embedding 1010 is received from a pre-processing component (e.g., pre-processor 122) utilized to generate the prompt to generative AI model 132 that caused generative AI model 132 to generate the invalid QL query. For instance, in a non-limiting example, query embedding 1010 is a request embedding corresponding to request 610 of FIG. 6 or a layer embedding corresponding to a ranked item included in the description of prompt 624 of FIG. 6 (e.g., layer embedding 618). In another alternative, candidate variable determiner 1006, another component of post-processor 126, or a component communicatively coupled to post-processor 126 estimates query embedding 1010. For instance, candidate variable determiner 1006 in accordance with an alternative embodiment estimates query embedding 1010 from database embeddings 1012, embeddings corresponding to request 610, data schema of data catalog 204, and/or other information associated with database 108.

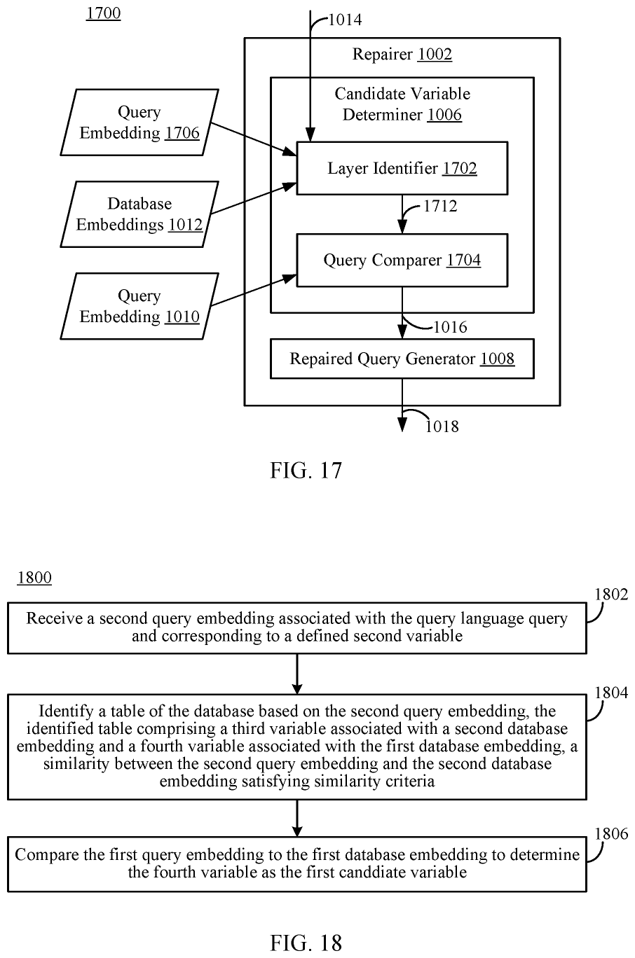

In step 1106, the first query embedding is compared to a set of database embeddings to determine a first candidate variable, the first candidate variable associated with a first database embedding of the set of database embeddings, a similarity between the first query embedding and the first database embedding satisfying similarity criteria. For example, candidate variable determiner 1006 of FIG. 10 compares query embedding 1010 to one or more database embeddings 1012 (“database embeddings 1012” herein) to determine a first candidate variable 1016 (“candidate variable 1016” herein). In this context, candidate variable determiner 1006 measures similarity between query embedding 1010 and embeddings of database embeddings 1012 utilizing similarity measuring techniques described elsewhere herein. In an example, if a similarity between query embedding 1010 and a database embedding satisfies similarity criteria (e.g., the level of similarity between the embeddings meets or exceeds a threshold), a variable corresponding to the database embedding is considered a (e.g., “potential”) candidate variable. In accordance with an embodiment, candidate variable determiner 1006 determines candidate variable 1016 as the variable with the highest similarity from among variables with similarities that satisfy the similarity criteria. In accordance with another embodiment, candidate variable determiner 1006 randomly selects candidate variable 1016 from among variables with similarities that satisfy the similarity criteria. In accordance with another embodiment, and as described with respect to FIGS. 17-19 (as well as elsewhere herein), candidate variable determiner 1006 selects candidate variable 1016 based on query embeddings corresponding to defined variables of the QL query. As shown in FIG. 10, candidate variable determiner 1006 provides candidate variable 1016 to repaired query generator 1008 and flow continues to step 1108. In accordance with an embodiment, candidate variable determiner 1006 determines candidate variable 1016 is a candidate variable (e.g., only) if substitution of candidate variable 1016 for the undefined first variable does not cause a previously defined variable of the invalid QL query to become undefined.

In step 1108, the first candidate variable is substituted in for the undefined first variable in the query language query to generate a first repaired query language query. For example, repaired query generator 1008 of FIG. 10 substitutes candidate variable 1016 in for the undefined first variable in the invalid QL query to generate a repaired QL query 1018.

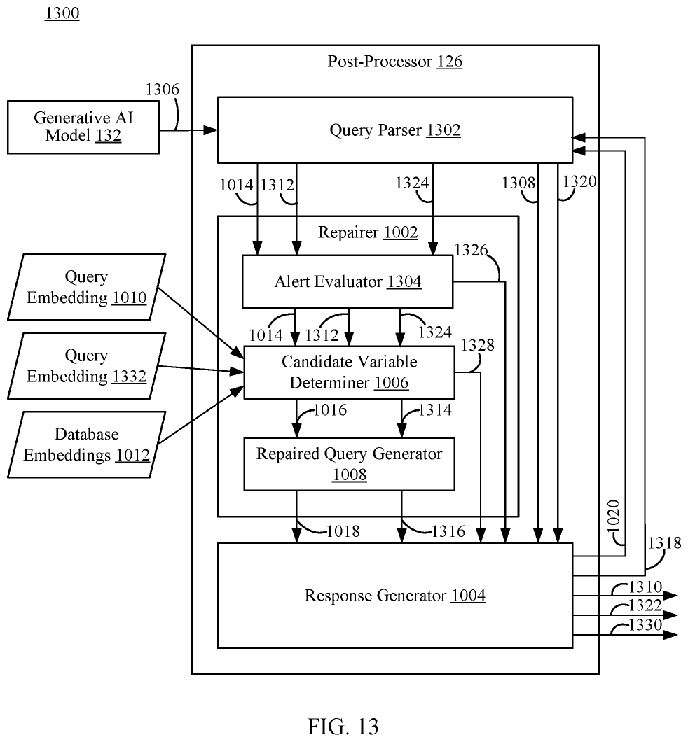

In step 1110, a first response comprising the first repaired query language query is generated. For example, response generator 1004 generates response 1020 comprising repaired QL query 1018. In examples, response generator 1004 generates response 1020 on behalf of generative AI model 132 (e.g., as described with respect to FIG. 12), provides response 1020 to a query parser for validation (e.g., as described with respect to FIG. 13), provides response 1020 to application 120 of FIG. 1, or provides response 1020 to database engine 134 of FIG. 1 for execution of repaired QL query 1018.

System 1000 and flowchart 1100 have been described with respect to FIGS. 10 and 11 for repairing a query based on a single determined candidate variable. However, in some implementations, a query is repaired based on multiple candidate variables. For instance, suppose in step 1106 candidate variable determiner 1006 determines multiple potential candidate variables suitable for replacing the undefined variable. In an alternative embodiment, candidate variable determiner 1006 provides (e.g., all of) the candidate variables to repaired query generator 1008. In examples, the candidate variables are ranked (e.g., from most similar to query embedding 1010 to least similar to query embedding 1010) or unranked. In this alternative embodiment, repaired query generator 1008 substitutes one of the candidate variables in for the undefined variable (e.g., as described in step 1108) to generate a provisionally repaired query. Repaired query generator 1008 (or another component of post-processor 126 or accessible to post-processor 126 (e.g., a query parser) not shown in FIG. 10 provided the provisionally repaired query by repaired query generator 1008) attempts to validate the provisionally repaired query. If the provisionally repaired query is valid, repaired query generator 1008 provides the provisionally repaired query to response generator 1004 as repaired query 1018. If the provisionally repaired query is invalid, repaired query generator 1008 substitutes in a different candidate variable and the process repeats until a valid query is generated or each candidate variable has been attempted. In accordance with another embodiment, repaired query generator (or the other component configured for query validation) validates (e.g., only) the substituted variable. In this context, if other variables or conditions place the query in an invalid state, repaired steps are performed according to other embodiments described herein (e.g., as described with respect to FIGS. 13-16). In this manner, post-processor 126 ensures the (e.g., first) undefined variable is repairable before attempting to repair other undefined variables or errors in the QL query.

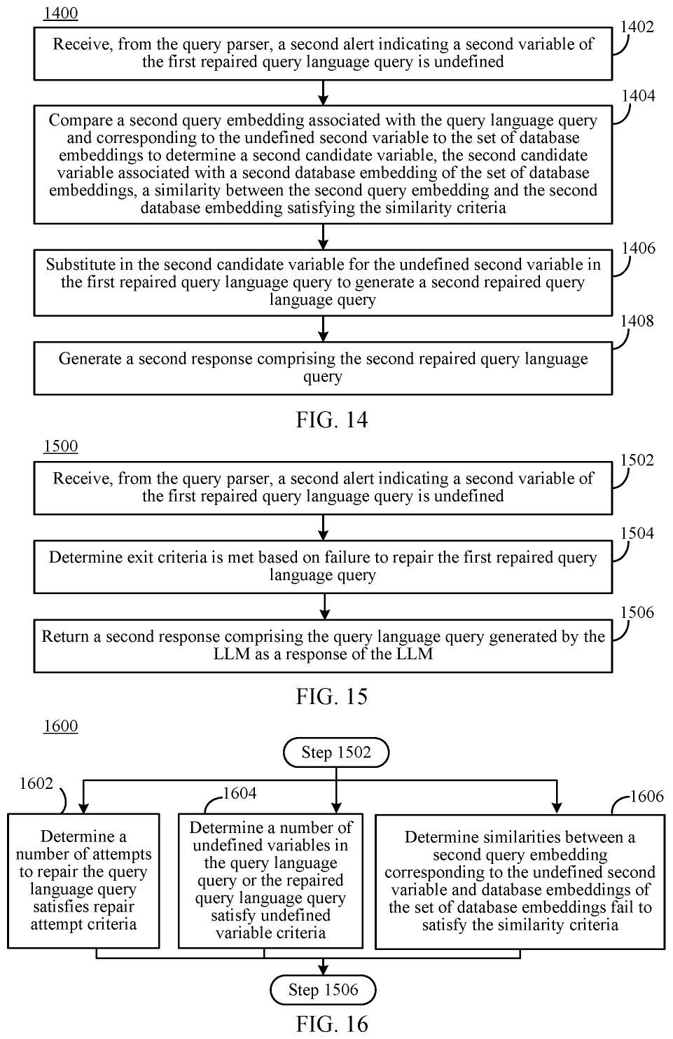

System 1000 and flowchart 1100 have been described with respect to FIGS. 10 and 11 for repairing a query with a single undefined variable; however, embodiments described herein are not so limited. For instance, in some examples, system 1000 repairs an undefined variable, checks if the repaired query language query is valid, identifies a second undefined variable, repairs the second undefined variable, etc., until a completely repaired query language query (e.g., free of undefined variables) is generated. An example process of iterating through multiple repairs is described further with respect to FIG. 14, as well as elsewhere herein. In some examples, system 1000 repairs multiple undefined variables at a time. For instance, consider the following example query, “Query A”:

TABLE A

| where var1 > 0
| where var2 == “lorem ipsum”

where TableA is a variable referencing a table and var1 and var2 are variables referencing columns in a query. Further suppose indication 1014 of FIG. 10 indicates var1 and var2 are undefined variables. In some examples, system 1000 repairs Query A by simultaneously (or otherwise in the same iteration of repair) replacing var1 and var2 with defined variables in a manner similar to that described with respect to flowchart 1100 of FIG. 11. For instance, suppose in step 1106 of flowchart 1100, candidate variable determiner 1006 identifies a table TableB (e.g., based on database embeddings 1012) that contains columns col1 and col2 corresponding to var1 and var2 and has a table embedding similar to a table embedding of TableA. In this context, candidate variable determiner 1006 determines TableB as a candidate replacement for TableA, col1 as a candidate replacement for var1, and col2 as a candidate replacement for var2. By repairing multiple undefined variables at once, repairer 1002 performs fewer iterations of repair, thereby (e.g., potentially) conserving resources and reducing time spent in generating repaired query language query.

In examples, response generator 1004 generates response 1020 comprising repaired QL query 1018 in various ways. For instance, in accordance with an embodiment, response generator 1004 provides response 1020 comprising repaired QL query 1018 as a response of generative AI model 132 or to another post-processing service/component for further post-processing. In examples, response generator 1004 operates in various ways to provide a response on behalf of a generative AI model. For example, FIG. shows a flowchart 1200 of a process for returning a response on behalf of a generative AI model, in accordance with an example embodiment. In accordance with an embodiment, system 1000 of FIG. 10 operates according to flowchart 1200. Note that flowchart 1200 need not be performed in all embodiments. In accordance with an embodiment, flowchart 1200 is a further example of step 1110 of flowchart 1100 of FIG. 11. Further structural and operational embodiments will be apparent to persons skilled in the relevant art(s) based on the following description of FIG. 12 with respect to FIG. 10.

Flowchart 1200 comprises step 1202. In step 1202, the first response is returned as a response of an LLM. For example, response generator 1004 of FIG. 10 returns response 1020 as a response of generative AI model 132. In this context, other components of language conversion engine 114 of FIG. 1 and/or communicatively coupled to language conversion engine 114 treat response 1020 as if generative AI model 132 provided the response. In this context, post-processor 126 provides a (e.g., nearly) seamless interface between generative AI model 132 and components of system 100 of FIG. 1 that expect an output from generative AI model 132 (e.g., application 120 and/or database engine 134).

In some embodiments, a repaired QL query is validated before providing a response on behalf of a generative AI model. In this context, response generator 1004 provides response 1020 to a post-processing service/component (either a sub-service/sub-component of post-processor 126 or another post-processing service/component external to post-processor 126) for validation. In examples, post-processor 126 is configured to validate a repaired QL query in various ways. For instance, FIG. 13 shows a block diagram of a system 1300 for repairing a query and returning a response on behalf of a generative AI model, in accordance with an example embodiment. As shown in FIG. 13, system 1300 comprises post-processor 126, generative AI model 132, query embedding 1010, and database embeddings 1012, as described with respect to FIG. 10. As also shown in FIG. 13, system 1300 comprises a query embedding 1332. Query embedding 1332 provides context for another variable in a QL query generated by generative AI model 132. In examples, query embedding 1332 is obtained, estimated, or otherwise received in a similar manner to query embedding 1010, as described with respect to FIG. 10.

As also shown in FIG. 13, post-processor 126 comprises repairer 1002 and response generator 1004, as described with respect to FIG. 10, and a query parser 1302. Query parser 1302 is configured to parse queries generated by generative AI model 132 and/or parse repaired queries generated by repaired query generator 1008 to determine if the query is valid. As shown in FIG. 13, query parser 1302 is a sub-service/component of post-processor 126. In an alternative embodiment, query parser 1302 is a separate component of system 1300 (e.g., executing on the same or a different server than post-processor 126). As further shown in FIG. 13, repairer 1002 comprises candidate variable 1006 and repaired query generator 1008, as described with respect to FIG. 10, and an alert evaluator 1304. Alert evaluator 1304 is configured to evaluate alerts generated by query parser 1302 and determine if exit criteria has been met, as described further with respect to FIGS. 15 and 16, as well as elsewhere herein.

In accordance with an embodiment, system 1300 operates in a manner similar to that described with respect to FIGS. 10 and 11. For instance, generative AI model 132 generates a QL query 1306. Query parser 1302 parses QL query 1306 to determine whether or not QL query 1306 is invalid (e.g., whether or not QL query 1306 comprises an undefined variable). If QL query 1306 is valid, QL parser 1302 causes response generator 1004 to generate a response on behalf of generative AI model 132 comprising QL query 1306 (not shown in FIG. 13 for brevity). In accordance with an embodiment, response generator 1004 provides the response to database engine 134 of FIG. 1 for execution of QL query 1306 against database 108. Alternatively, response generator 1004 provides the response to application 120 of FIG. 1. In an example implementation where response generator 1004 provides the response to application 120, application 120 or a user interacting with a user interface of application 120 reviews QL query 1306 (e.g., to determine if QL query 1306 is an expected or appropriate conversion of a natural language input), causes execution of QL query 1306 (e.g., by providing QL query 1306 to database engine 134), and/or otherwise utilizes QL query 1306 for review and/or performing database operations, as described elsewhere herein and/or as would otherwise be understood by a person ordinarily skilled in the relevant art(s) having benefit of this disclosure.

If query parser 1302 determines QL query 1306 is invalid, QL parser 1302 provides alert 1014 to candidate variable determiner 1006 and a query repair operation is performed in a manner similar to that described with respect to flowchart 1100 of FIG. 11. In this context, and as shown in FIG. 13, response generator 1004 provides response 1020 comprising repaired QL query 1018 to query parser 1302. Query parser 1302 parses repaired QL query 1018 to determine if repaired QL query 1018 is valid. If query parser 1302 determines repaired QL query 1018 is valid, query parser 1302 provides an indication 1308 to response generator 1004. In this context, response generator 1004 generates a response 1310 on behalf of generative AI model 132. Response 1310 comprises repaired QL query 1018. In accordance with an embodiment, response 1310 is provided to database engine 134 for execution of repaired QL query 1018. Alternatively, response 1310 is provided to application 120 for review and/or performing database operations.

If query parser 1302 determines repaired QL query 1018 is invalid, query parser 1302 provides an alert 1312 to repairer 1002 that causes repairer 1002 to perform iterative repair of the query generated by generative AI model 132. In examples, repairer 1002 operates to iteratively repair a query in various ways. To better understand repairer 1002 iteratively repairing a query, FIG. 13 is further described with respect to FIG. 14. FIG. 14 shows a flowchart 1400 of a process for iteratively repairing a query generated by a generative AI model, in accordance with an example embodiment. In accordance with an embodiment, system 1300 of FIG. 13 operates according to flowchart 1400. Not all steps of flowchart 1400 need be performed in all embodiments. In an example, one or more steps of flowchart 1400 are performed subsequent to one or more steps of flowchart 1100. Further structural and operational embodiments will be apparent to persons skilled in the relevant art(s) based on the following description of FIG. 14 with respect to FIG. 13.

Flowchart 1400 begins with step 1402. In step 1402, a second alert indicating a second variable of the first repaired QL query is undefined is received from the query parser. For example, alert evaluator 1304 receives alert 1312 indicating a second variable of repaired query 1018 is undefined from query parser 1302. In accordance with an embodiment, the second variable is a different variable than the variable that was indicated in alert 1014. In an example, the second variable was another undefined variable of query 1306. Alternatively, the second variable being undefined was introduced as a result of generation of repaired query 1018 (e.g., by introduction of a new variable that is undefined, by removal of a column, table, or other item that the variable referenced, etc.). As shown in FIG. 13, alert evaluator 1304 receives alert 1312 and provides alert 1312 to candidate variable determiner 1006. Alert evaluator 1304 is configured to determine if exit criteria is met (e.g., criteria for determining repair of the QL query has failed). Additional details regarding alert evaluator 1304 are described with respect to FIGS. 15 and 16, as well as elsewhere herein. In some embodiments, repairer 1002 does not include alert evaluator 1304. In this context, candidate variable determiner 1006 receives alert 1312 from query parser 1302.

In step 1404, a second query embedding associated with the QL query and corresponding to the undefined second variable is compared to the set of database embeddings to determine a second candidate variable, the second candidate variable associated with a second database embedding of the set of database embeddings, a similarity between the second query embedding and the second database embedding satisfying the similarity criteria. For example, candidate variable determiner 1006 of FIG. 13 receives a query embedding 1332 corresponding to the undefined second variable. Candidate variable determiner 1006 receives query embedding 1332 in a similar manner described with respect to step 1104 of flowchart 1100 of FIG. 11. Query embedding 1332 comprises at least one of a cluster embedding described a context of a cluster of database 108, a table embedding describing a context of a table of database 108, a column embedding describing a context of a column in a table of database 108, a value embedding describing a context of a value in a column of a table of database 108, and/or any other type of embedding describing a context of one or more values of database 108, as described elsewhere herein. Candidate variable determiner 1006 compares query embedding 1332 to database embeddings 1012 to determine a second candidate variable 1314 (“candidate variable 1314”), wherein candidate variable 1314 is associated with a database embedding of database embeddings 1012 with a similarity to query embedding 1332 satisfying similarity criteria. In embodiments, candidate variable determiner 1006 determines candidate variable 1314 in a similar way to the techniques described with respect to step 1106 of flowchart 1100 of FIG. 11.

In step 1406, the second candidate variable is substituted in for the undefined second variable in the first repaired QL query to generate a second repaired QL query. For example, repaired query generator 1008 of FIG. 13 substitutes candidate variable 1314 in for the undefined second variable in repaired QL query 1018 to generate a second repaired QL query 1316 (“repaired QL query 1316”). In examples, repaired query generator 1008 generates repaired QL query 1316 in a similar manner to generation of repaired QL query 1018 as described with respect to step 1108 of flowchart 1100 of FIG. 11. As shown in FIG. 13, repaired query generator 1008 provides repaired QL query 1316 to response generator 1004 and flow continues to step 1408.

In step 1408, a second response comprising the second repaired QL query is generated. For example, response generator 1004 of FIG. 13 generates a response 1318 comprising repaired QL query 1316. As shown in FIG. 13, response generator 1004 provides response 1318 to query parser 1302. In this context, query parser 1302 parses repaired QL query 1316 to determine if it is valid. In an example, if query parser 1302 determines repaired QL query 1316 is invalid, query parser 1302 provides an alert 1324 indicating the query's invalidity and the process described with respect to steps 1402-1408 of flowchart 1400 repeats with an attempt to repair the invalid query (e.g., by substituting another undefined query to generate a third repaired QL query). In some embodiments, the process repeats until a valid repaired QL query is generated. Alternatively, and as described further with respect to FIGS. 15 and 16 (as well as elsewhere herein), the process repeats until a repaired query is generated or exit criteria is met. If query parser 1302 determines repaired QL query 1316 is valid, query parser 1302 provides an indication 1320 to response generator 1004. In this context, response generator 1004 generates a response 1322 on behalf of generative AI model 132. Response 1322 comprises repaired QL query 1316. In accordance with an embodiment, response 1322 is provided to database engine 134 for execution of repaired QL query 1316. Alternatively, response 1322 is provided to application 120 for review and/or performing database operations.

In some embodiments, repairer 1002 of FIG. 13 determines that it is unable to repair an invalid QL query. In order to better understand embodiments of repairer 1002 determining that it is unable to repair an invalid QL query, FIG. 13 is further described with respect to FIG. 15. FIG. 15 shows a flowchart 1500 of a process for returning a query generated by a generative AI model on behalf of the generative AI model, in accordance with an example embodiment. In accordance with an embodiment, system 1300 of FIG. 13 operates according to flowchart 1500. Not all steps of flowchart 1500 need be performed in all embodiments. In an example, one or more steps of flowchart 1500 are performed subsequent to one or more steps of flowcharts 1100 of FIGS. 11 and/or 1400 of FIG. 14. Further structural and operational embodiments will be apparent to persons skilled in the relevant art(s) based on the following description of FIG. 15 with respect to FIG. 13.

Flowchart 1500 begins with step 1502. In step 1502, a second alert indicating a second variable of the first repaired QL query is undefined is received from the query parser. For example, repairer 1002 of FIG. 13 receives alert 1312 from query parser 1302 in a similar manner as described with respect to step 1402 of flowchart 1400 of FIG. 14. In an example, and as shown in FIG. 13, alert evaluator 1304 receives alert 1312 indicating repaired QL query 1018 is invalid. In an alternative embodiment wherein repairer 1002 does not include alert evaluator 1304, candidate variable determiner 1006 receives alert 1312 indicating repaired QL query 1018 is invalid.

In step 1504, a determination that exit criteria is met is made based on failure to repair the first repaired QL query. For example, repairer 1002 of FIG. 13 determines that exit criteria is met based on failure to repair the invalid version of repaired QL query 1018. Examples of exit criteria include, but are not limited to, a similarity between a query embedding (e.g., query embedding 1332) and database embeddings failing to satisfy similarity criteria, a number of undefined variables in a QL query satisfying an undefined variable criteria, a number of attempts to repair a QL query satisfying repair attempt criteria, and/or any other criteria suitable for determining repairer 1002 failed to repair a QL query or iteratively repair a query. For instance, in accordance with an embodiment, repairer 1002 determines an amount of time spent attempting to repair the QL query has exceeded a time limit threshold. Depending on the implementation, alert evaluator 1304, candidate variable determiner 1006, or another component of repairer 1002 determines the exit criteria has been met. Repairer 1002 provides an indication to response generator 1004 indicating the exit criteria has been met and flow continues to step 1506. Additional details regarding exit criteria are described with respect to FIG. 16, as well as elsewhere herein.

In step 1506, a second response comprising the QL query generated by the LLM is returned as a response of the LLM. For example, response generator 1004 receives an indication that exit criteria has been met and returns a response 1330 comprising QL query 1306 generated by generative AI model 132 as a response of generative AI model 132. In accordance with an embodiment, response 1330 also indicates QL query 1306 is an invalid query. For instance, response 1330 in accordance with an embodiment includes diagnostic information indicating QL query 1306 is invalid including any undefined variables or other errors with QL query 1306. In accordance with an embodiment, response generator 1004 provides response 1330 to application 120 for further review and/or revision of QL query 1306.

In examples, repairer 1002 (or a subcomponent thereof) determines that exit criteria is met in various ways. For example, FIG. 16 shows a flowchart 1600 of a process for determining exit criteria is met, in accordance with an example embodiment. In accordance with an embodiment, repairer 1002 of FIG. 13 operates according to flowchart 1600. Not all steps of flowchart 1600 need be performed in all embodiments. In an example, flowchart 1600 is a further example of step 1504 of flowchart 1500, as described with respect to FIG. 15. Further structural and operational embodiments will be apparent to persons skilled in the relevant art(s) based on the following description of FIG. 16 with respect to FIG. 13.

Flowchart 1600 begins with step 1502 of flowchart 1500 of FIG. 15. In step 1502, a second alert is received from a query parser, as described with respect to FIG. 15. Once the second alert is received, flow continues to step 1602, step 1604, and/or step 1606, each of which are further examples of step 1504 of flowchart 1500.

For instance, suppose flow continues to step 1602. In step 1602, a number of attempts to repair the query language query is determined to satisfy repair attempt criteria. For example, alert evaluator 1304 of FIG. 13 receives alert 1312 from query parser 1302 and determines a number of attempts to repair QL query 1306 has satisfied repair attempt criteria. Example repair attempt criteria include, but are not limited to, a number of attempts that, when met, causes alert evaluator 1304 to indicate repair has failed, a number of attempts that, when exceeded, causes alert evaluator 1304 to indicate repair has failed, a number of alerts received from query parser 1302 that, when met or exceeded, causes alert evaluator 1304 to indicate repair has failed, and/or any other criteria that, when satisfied, causes alert evaluator 1304 to indicate repair has failed. As shown in FIG. 13, alert evaluator 1304 generates an indication 1326 and provides indication 1326 to response generator 1004, and flow continues to step 1506, as described with respect to FIG. 15. In this context, indication 1326 indicates repair has failed due to repair attempt criteria being satisfied.

In an alternative embodiment, suppose flow continues from step 1502 to step 1604. In step 1604, a number of undefined variables in the query language query or the repaired query language query is determined to satisfy undefined variable criteria. For example, alert evaluator 1304 of FIG. 13 receives alert 1312 and determines a number of undefined variables in repaired QL query 1018 satisfies undefined variable criteria. Example undefined variable criteria include, but are not limited to, a number of undefined variables in the QL query exceeding or meeting a threshold, a number of undefined variables introduced as a result of a query repair attempt exceeding or meeting a threshold (e.g., as determined based on a difference between the number of undefined variables in the repaired QL query and the number of undefined variables in a QL query (e.g., the original QL query or a previously generated repaired QL query) from the previous iteration of query repair), and/or any other criteria that, when satisfied, indicates query repair has failed based on the number of undefined variables in the QL query. As shown in FIG. 13, alert evaluator 1304 generates indication 1326 and provides indication 1326 to response generator 1004, and flow continues to step 1506, as described with respect to FIG. 15. In this context, indication 1326 indicates repair has failed due to undefined variable criteria being satisfied.

In another alternative embodiment, suppose flow continues to step 1606. In step 1606, similarities between a second query embedding corresponding to the undefined second variable and database embeddings of the set of database embeddings are determined to fail to satisfy a similarity criteria. For example, candidate variable determiner 1006 of FIG. 13 compares query embedding 1332 to database embeddings 1012 in a similar manner to that described with respect to step 1404 of flowchart 1400 of FIG. 14. However, in this example embodiment, suppose candidate variable determiner 1006 determines none of the similarities between query embedding 1332 and any of database embeddings 1012 satisfy the similarity criteria. In other words, candidate variable determiner 1006 fails to determine a database embedding that is similar to query embedding 1332. In this context, and as shown in FIG. 13, candidate variable determiner 1006 generates indication 1328 indicating the similarities fail to satisfy similarity criteria and provides indication 1328 to response generator 1004, and flow continues to step 1506, as described with respect to FIG. 15.

Flowcharts 1500 and 1600 of FIGS. 15 and 16 are described with respect to failing to repair the first repaired QL query wherein the first repaired QL query comprises a second undefined variable. In alternative examples, steps similar to those described with respect to flowcharts 1500 and/or 1600 are performed with response to failing to repair a QL query comprising one undefined variable, a QL query comprising multiple undefined variables (including a second undefined variable and greater numbers of undefined variables), a first repaired QL query comprising multiple undefined variables, any iteration of repaired QL queries subsequent to a first repaired query (e.g., a second repaired QL query, a third repaired QL query, etc.), and/or any other QL query generated by a generative AI model and/or repaired query generated by repairer 1002, as described elsewhere herein. Furthermore, in examples, undefined variables exist in an original QL query generated by the generative AI model and/or are introduced as a result of repairer 1002 repairing a QL query.

In examples, candidate variable determiner 1006 of FIG. 10 operates in various ways to determine a candidate variable. In accordance with one or more embodiments, candidate variable determiner 1006 is configured to leverage multiple query embeddings to determine a candidate variable. For instance, FIG. 17 shows a block diagram of a system 1700 for repairing a query generated by a generative AI model, in accordance with another example embodiment. As shown in FIG. 17, system 1700 comprises repairer 1002 (comprising candidate variable determiner 1006 and repaired query generator 1008), query embedding 1010, and database embeddings 1012 as described with respect to FIG. 10, and a query embedding 1706. Query embedding 1706 provides context for another variable in a QL query generated by generative AI model 132 (e.g., QL query 1306 of FIG. 13 or another QL query). In examples, query embedding 1706 is obtained or otherwise received in a similar manner to query embedding 1010, as described with respect to FIG. 10. As also shown in FIG. 17, candidate variable determiner 1006 comprises a layer identifier 1702 and a query comparer 1704. In accordance with an embodiment, layer identifier 1702 and/or query comparer 1704 are implemented as sub-services/sub-components of candidate variable determiner 1006.

To better understand the operation of candidate variable determiner 1006, layer identifier 1702, query comparer 1704, and other components of system 1700, system 1700 is described with respect to FIG. 18. FIG. 18 shows a flowchart 1800 of a process for determining a candidate variable, in accordance with an example embodiment. In accordance with an embodiment, candidate variable determiner 1006 of FIG. 17 operates according to flowchart 1800. Not all steps of flowchart 1800 need be performed in all embodiments. In an example, one or more steps of flowchart 1800 are a further example of step 1104 and/or step 1106 of flowchart 1100, as described with respect to FIG. 11. Further structural and operational embodiments will be apparent to persons skilled in the relevant art(s) based on the following description of FIGS. 17 and 18.

Flowchart 1800 begins with step 1802. In step 1802, a second query embedding associated with a query language query and corresponding to a defined second variable is received. For example, layer identifier 1702 of FIG. 17 receives query embedding 1706 associated with the QL query included in alert 1014 and corresponding to a defined second variable of the QL query. Query embedding 1706 comprises at least one of a cluster embedding described a context of a cluster of database 108, a table embedding describing a context of a table of database 108, a column embedding describing a context of a column in a table of database 108, a value embedding describing a context of a value in a column of a table of database 108, and/or any other type of embedding describing a context of one or more values of database 108, as described elsewhere herein. In examples, layer identifier 1702 receives query embedding 1706 in a similar manner to the techniques described with respect to step 1104 of flowchart 1100 of FIG. 11. While FIG. 17 illustrates layer identifier 1702 receiving a single query embedding, in another example embodiment, layer identifier 1702 receives multiple query embeddings (e.g., query embeddings corresponding to respective defined variables of the QL query).

In step 1804, a table of the database is identified based on the second query embedding, the identified table comprises a third variable associated with a second database embedding and a fourth variable associated with the first database embedding, a similarity between the second query embedding and the second database embedding satisfies similarity criteria. For example, layer identifier 1702 of FIG. 17 identifies a table of database 108 of FIG. 1 based on query embedding 1706. The identified table comprises a third variable associated with a second database embedding of database embeddings 1012 and a fourth variable associated with a first database embedding (e.g., the database embedding described in step 1106 having a similarity to query embedding 1010 that satisfies similarity criteria). A similarity between query embedding 1706 and the second database embedding satisfies similarity criteria. In examples, layer identifier 1702 determines the similarity between query embedding 1706 and the second database embedding satisfies similarity criteria utilizing any of the techniques for measuring similarity between embeddings described elsewhere herein. To better illustrate the operation of layer identifier 1702, consider the example query, Query A, described with respect to FIGS. 10 and 11. In that example, suppose query embedding 1706 represents embeddings of TableA, a defined table. In this manner, layer identifier 1702 determines a similarity between query embedding 1706 of TableA and a “second database embedding” of TableB, thereby identifying TableB as a candidate replacement table for TableA.

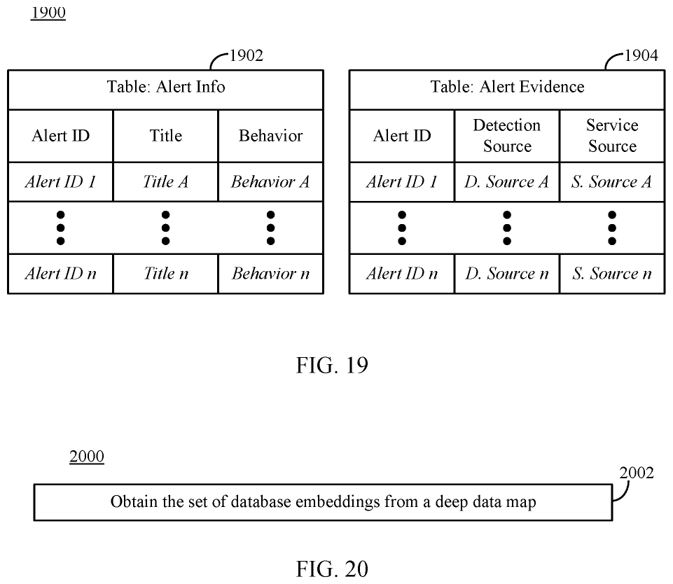

As another way for further understanding the operation of layer identifier 1702 performing step 1804, step 1804 is described with respect to FIG. 19. FIG. 19 depicts an example illustration 1900 of tables of a database (“example 1900”), in accordance with an example embodiment. As shown in FIG. 19, example 1900 comprises a table 1902 entitled “Table: Alert Info” and a table 1904 entitled “Table: Alert Evidence.” Table 1902 comprises three columns, a first column titled “Alert ID” and comprising values “Alert ID 1”-“Alert ID n,” a second column titled “Title” and comprising values “Title A”-“Title n,” and a third column titled “Behavior” and comprising values “Behavior A”-“Behavior n.” Table 1904 comprises three columns, a first column titled “Alert ID” and comprising values “Alert ID 1”-“Alert ID n,” a second column titled “Detection Source” and comprising values “D. Source A”-“D. Source n,” and a third column titled “Service Source” and comprising values “S. Source A”-“S. Source n.” Tables 1902 and 1904 are illustrative examples of tables within a database (e.g., database 108 of FIG. 1). In examples, a database includes any number of tables (one table, two tables, more than two tables, tens of tables, hundreds of tables, and even greater numbers of tables). Furthermore, in examples, a table within a database includes any number of columns (e.g., three columns, less than three columns, more than three columns, tens of columns, hundreds of columns, etc.) of any number of values (e.g., one value, more than one value, tens of values, hundreds of values, etc.). Further structural and operational embodiments will be apparent to persons skilled in the relevant art(s) based on the following description of step 1804 of FIG. 18 with respect to tables 1902 and 1904 of FIG. 19.

As a non-limiting example described with respect to step 1804 of FIG. 18 and FIG. 19, suppose the QL query describes an undefined variable for a column titled “Device ID” (e.g., the first variable) and a defined variable for a column titled “Alert ID” (e.g., the second variable). Further suppose QL query is executed against table 1902. As shown in FIG. 19, table 1902 does not include a column with a title “Device ID,” therefore, the QL query is undefined. Repairer 1002 of FIG. 17 searches for another table in an attempt to repair the QL query. In this context, layer identifier 1702 compares embeddings of columns of other tables to embeddings of the Alert ID variable of the QL query (e.g., query embedding 1706) to identify potential alternative tables that already include the defined variable of the QL query. In this context, the identified tables comprises table 1904 of FIG. 19. In this context, the database embedding associated with the Alert ID column of table 1904 has a similarity to query embedding 1706 that satisfies similarity criteria. As shown in FIG. 17, layer identifier 1702 provides one or more identified tables 1712 to query comparer 1704 and flow continues to step 1806.

In step 1806, the first query embedding is compared to the first database embedding to determine the fourth variable as the first candidate variable. For example, query comparer 1704 of FIG. 17 compares query embedding 1010 to database embeddings 1012 to determine the fourth variable of the table identified in step 1804 is candidate variable 1016. With continued reference to FIG. 19 and the non-limiting example described with respect to step 1804, suppose query embedding 1010 corresponds to the undefined variable for a column titled “Device ID.” In this example, query comparer 1704 compares query embedding 1010 to column embeddings of database embeddings 1012 corresponding to columns of identified tables 1712. For instance, suppose query comparer 1704 compares query embedding 1010 to column embeddings corresponding to the columns Detection Source and Service Source of table 1904. In this example, suppose query comparer 1704 determines a similarity between query embedding 1010 and a database embedding corresponding to the Detection Source column satisfies a similarity criteria. In this context, query comparer 1704 determines the Detection Source column is the first candidate variable and flowchart 1800 continues to step 1108 of flowchart 1100 of FIG. 11. For instance, with respect to the non-limiting example, repaired query generator 1008 of FIG. 10 in accordance with an embodiment generates a repaired QL query by substituting “Detection Source” in for “Device ID” and by referencing table 1904 instead of table 1902.

System 1700 and flowchart 1800 have been described with respect to FIGS. 10 and 11 for repairing a query with a single undefined variable; however, as stated elsewhere, embodiments described herein are not so limited. In some examples, system 1700 replaces multiple undefined variables in a query (e.g., in different iterations of repair or in the same iteration of repair). An example of repairing multiple undefined variables in different iterations of repair is described with respect to FIG. 14 (as well as elsewhere herein) and an example of repairing multiple undefined variables in the same iteration wherein the variables are in the same table (or other tier of database 108) is described with respect to an alternative embodiment to FIGS. 10 and 11 (as well as elsewhere herein). In some examples, repairer 1002 generates a repaired query by repairing multiple undefined variables located in different tables (or other tier of database 108). For instance, as a non-limiting example, considering again the example query Query A, suppose candidate variable determiner 1006 (or a subcomponent thereof) identified TableB comprising col1 as a suitable replacement for var1 and TableC comprising col2 as a suitable replacement for var2. In this example, candidate variable determiner 1006 determines a similarity between the embeddings of TableA and TableB satisfies similarity criteria and repairs Query A at the location of var1 (i.e., by replacing var1 with col1). Candidate variable determiner 1006 then determines a similarity between the embeddings of TableA and TableC satisfies similarity criteria and repairs Query A at the location of var2 (i.e., by replacing var2 with col2). In this context, candidate variable determiner 1006 provides greater extensibility in repairing queries comprising undefined variables.

In examples, candidate variable determiner 1006 of FIG. 10 operates to obtain a set of database embeddings in various ways. For instance, in accordance with an example embodiment, database embeddings are pre-configured (e.g., manually) by a developer of system 1000 and/or database 108. In another alternative embodiment, candidate variable determiner 1006 obtains or otherwise receives database embeddings 1012 from an embeddings file stored in memory accessible to post-processor 126. In another alternative embodiment, candidate variable determiner 1006 obtains or otherwise receives database embeddings 1012 from a deep data map (e.g., deep data map 130 of FIG. 1). In examples, candidate variable determiner 1006 of FIG. 10 obtains or otherwise receives database embeddings 1012 from deep data map 130 in various ways. For instance, FIG. 20 shows a flowchart 2000 of a process for obtaining a set of database embeddings, in accordance with an example embodiment. In accordance with an embodiment, candidate variable determiner 1006 of FIG. 10 operates according to flowchart 2000. Flowchart 2000 need not be performed in all embodiments. In an example, flowchart 2000 is a sub-step of step 1106 of flowchart 1100, as described with respect to FIG. 11. Further structural and operational embodiments will be apparent to persons skilled in the relevant art(s) based on the following description of FIG. 20 with respect to FIG. 10.

Flowchart 2000 includes step 2002. In step 2002, a set of database embeddings is obtained from a deep data map. For example, candidate variable determiner 1006 of FIG. 10 (or another component or subcomponent of post-processor 126) obtains database embeddings 1012 from deep data map 130 of FIG. 10. Depending on the implementation, candidate variable determiner 1006 requests a managing service of deep data map 130 for database embeddings 1012 (e.g., a data storage service managing a data store that maintains deep data map 130 (e.g., a storage service of storage 116, not shown in FIG. 1)), accesses deep data map 130 (e.g., directly or indirectly) to obtain database embeddings 1012, receives database embeddings 1012 in an alert received from a query parser, receives database embeddings 1012 in a signal received subsequent to (and/or responsive to) such an alert, and/or otherwise receives database embeddings of deep data map 130 utilizing techniques described herein and/or as would otherwise be understood by a person of ordinary skill in the relevant art(s) having benefit of this disclosure.

Thus, example embodiments for repair of an invalid QL query generated by a generative AI model have been described with respect to FIGS. 10-20. As described herein, embodiments of query repair utilizing embeddings enable repair without requiring a re-call to the generative AI model, thereby reducing the time taken and the compute resources utilized to resolve an invalid query. Furthermore, through the use of embeddings, a post-processor is able to identify variables that are semantically similar to an undefined variable (or a defined variable, as shown in and described with respect to FIGS. 17-19). This aspect improves the accuracy of query repairs and enables automatic query repair (e.g., without requiring manual repair or the use of generative AI model to repair the query). Furthermore, candidate variables are able to be identified without relying on exact text matching (e.g., a candidate column name to replace an undefined column name does not have to exactly match, rather the semantic similarity (based on embeddings of the column and the undefined variable) satisfy similarity criteria). This increases the possibility of post-processors finding a candidate variable and successfully repairing the query.

### VI. Example Computer System Implementation

Each of computing device 102, conversion server 104, embeddings server 106, database 108, model server 110, engine server 112, storage 116, system 200, system 600, system 800, system 1000, system 1300, and/or system 1700 are implemented in hardware, or hardware combined with one or both of software and/or firmware. For example, language conversion engine 114, application 120, embedding model 128, generative AI model 132, database engine 134, embedding model interface 140, summarizer 206, deep data map generator 208, request embedding determiner 602, layer predictor 604, layer filter 802, repairer 1002, response generator 1004, query parser 1302, alert evaluator 1304, and/or each of the components described therein, and/or the steps of flowcharts 300, 400, 500, 700, 900, 1100, 1200, 1400, 1500, 1600, 1800, and/or 2000 are each implemented as computer program code/instructions configured to be executed in one or more processors and stored in a computer readable storage medium. Alternatively, language conversion engine 114, application 120, embedding model 128, generative AI model 132, database engine 134, embedding model interface 140, summarizer 206, deep data map generator 208, request embedding determiner 602, layer predictor 604, layer filter 802, repairer 1002, response generator 1004, query parser 1302, alert evaluator 1304, and/or each of the components described therein, and/or the steps of flowcharts 300, 400, 500, 700, 900, 1100, 1200, 1400, 1500, 1600, 1800, and/or 2000 are each implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 21. FIG. 21 shows a block diagram of an exemplary computing environment 2100 that includes a computing device 2102. Computing device 2102 is an example of computing device 102, conversion server 104, embeddings server 106, database 108, model server 110, and/or engine server 112, which each include one or more of the components of computing device 2102. In some embodiments, computing device 2102 is communicatively coupled with devices (not shown in FIG. 21) external to computing environment 2100 via network 2104. In accordance with an embodiment, network 2104 is an example of network 118 of FIG. 1. Network 2104 comprises one or more networks such as local area networks (LANs), wide area networks (WANs), enterprise networks, the Internet, etc. In examples, network 2104 includes one or more wired and/or wireless portions. In some examples, network 2104 additionally or alternatively includes a cellular network for cellular communications. Computing device 2102 is described in detail as follows.

Computing device 2102 can be any of a variety of types of computing devices. Examples of computing device 2102 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 2102 is a stationary computing device such as a desktop computer, a personal computer (PC), a stationary server device, a minicomputer, a mainframe, a supercomputer, etc.

As shown in FIG. 21, computing device 2102 includes a variety of hardware and software components, including a processor 2110, a storage 2120, a graphics processing unit (GPU) 2142, a neural processing unit (NPU) 2144, one or more input devices 2130, one or more output devices 2150, one or more wireless modems 2160, one or more wired interfaces 2180, a power supply 2182, a location information (LI) receiver 2184, and an accelerometer 2186. Storage 2120 includes memory 2156, which includes non-removable memory 2122 and removable memory 2124, and a storage device 2188. Storage 2120 also stores an operating system 2112, application programs 2114, and application data 2116. Wireless modem(s) 2160 include a Wi-Fi modem 2162, a Bluetooth modem 2164, and a cellular modem 2166. Output device(s) 2150 includes a speaker 2152 and a display 2154. Input device(s) 2130 includes a touch screen 2132, a microphone 2134, a camera 2136, a physical keyboard 2138, and a trackball 2140. Not all components of computing device 2102 shown in FIG. 21 are present in all embodiments, additional components not shown may be present, and in a particular embodiment any combination of the components are present. In examples, components of computing device 2102 are mounted to a circuit card (e.g., a motherboard) of computing device 2102, integrated in a housing of computing device 2102, or otherwise included in computing device 2102. The components of computing device 2102 are described as follows.

In embodiments, a single processor 2110 (e.g., central processing unit (CPU), microcontroller, a microprocessor, signal processor, ASIC (application specific integrated circuit), and/or other physical hardware processor circuit) or multiple processors 2110 are present in computing device 2102 for performing such tasks as program execution, signal coding, data processing, input/output processing, power control, and/or other functions. In examples, processor 2110 is a single-core or multi-core processor, and each processor core is single-threaded or multithreaded (to provide multiple threads of execution concurrently). Processor 2110 is configured to execute program code stored in a computer readable medium, such as program code of operating system 2112 and application programs 2114 stored in storage 2120. The program code is structured to cause processor 2110 to perform operations, including the processes/methods disclosed herein. Operating system 2112 controls the allocation and usage of the components of computing device 2102 and provides support for one or more application programs 2114 (also referred to as “applications” or “apps”). In examples, application programs 2114 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 2110 includes one or more general processors (e.g., CPUs) configured with or coupled to one or more hardware accelerators, such as one or more NPUs 2144 and/or one or more GPUs 2142.

Any component in computing device 2102 can communicate with any other component according to function, although not all connections are shown for ease of illustration. For instance, as shown in FIG. 21, bus 2106 is a multiple signal line communication medium (e.g., conductive traces in silicon, metal traces along a motherboard, wires, etc.) present to communicatively couple processor 2110 to various other components of computing device 2102, although in other embodiments, an alternative bus, further buses, and/or one or more individual signal lines is/are present to communicatively couple components. Bus 2106 represents one or more of any of several types of bus structures, including a memory bus or memory controller, a peripheral bus, an accelerated graphics port, and a processor or local bus using any of a variety of bus architectures.

Storage 2120 is physical storage that includes one or both of memory 2156 and storage device 2188, which store operating system 2112, application programs 2114, and application data 2116 according to any distribution. Non-removable memory 2122 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 2122 includes main memory and is separate from or fabricated in a same integrated circuit as processor 2110. As shown in FIG. 21, non-removable memory 2122 stores firmware 2118 that is present to provide low-level control of hardware. Examples of firmware 2118 include BIOS (Basic Input/Output System, such as on personal computers) and boot firmware (e.g., on smart phones). In examples, removable memory 2124 is inserted into a receptacle of or is otherwise coupled to computing device 2102 and can be removed by a user from computing device 2102. Removable memory 2124 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 2188 are present that are internal and/or external to a housing of computing device 2102 and are or are not removable. Examples of storage device 2188 include a hard disk drive, a SSD, a thumb drive (e.g., a USB (Universal Serial Bus) flash drive), or other physical storage device.

One or more programs are stored in storage 2120. Such programs include operating system 2112, one or more application programs 2114, and other program modules and program data. Examples of such application programs include computer program logic (e.g., computer program code/instructions) for implementing language conversion engine 114, application 120, embedding model 128, generative AI model 132, database engine 134, embedding model interface 140, summarizer 206, deep data map generator 208, request embedding determiner 602, layer predictor 604, layer filter 802, repairer 1002, response generator 1004, query parser 1302, alert evaluator 1304, and/or each of the components described therein, as well as any of flowcharts 300, 400, 500, 700, 900, 1100, 1200, 1400, 1500, 1600, 1800, and/or 2000, and/or any individual steps thereof.

Storage 2120 also stores data used and/or generated by operating system 2112 and application programs 2114 as application data 2116. Examples of application data 2116 include web pages, text, images, tables, sound files, video data, and other data. In examples, application data 2116 is sent to and/or received from one or more network servers or other devices via one or more wired or wireless networks. Storage 2120 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 2102 through one or more input devices 2130 and receives information from computing device 2102 through one or more output devices 2150. Input device(s) 2130 includes one or more of touch screen 2132, microphone 2134, camera 2136, physical keyboard 2138 and/or trackball 2140 and output device(s) 2150 includes one or more of speaker 2152 and display 2154. Each of input device(s) 2130 and output device(s) 2150 are integral to computing device 2102 (e.g., built into a housing of computing device 2102) or are external to computing device 2102 (e.g., communicatively coupled wired or wirelessly to computing device 2102 via wired interface(s) 2180 and/or wireless modem(s) 2160). Further input devices 2130 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 2154 displays information, as well as operating as touch screen 2132 by receiving user commands and/or other information (e.g., by touch, finger gestures, virtual keyboard, etc.) as a user interface. Any number of each type of input device(s) 2130 and output device(s) 2150 are present, including multiple microphones 2134, multiple cameras 2136, multiple speakers 2152, and/or multiple displays 2154.

In embodiments where GPU 2142 is present, GPU 2142 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 2142 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 2144 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 2128. In an example, NPU 2144 is configured for a data-driven parallel computing and is highly efficient at processing massive multimedia data such as videos and images and processing data for neural networks. NPU 2144 is configured for efficient handling of AI-related tasks, such as speech recognition, background blurring in video calls, photo or video editing processes like object detection, etc.

In embodiments disclosed herein that implement ML models, NPU 2144 can be utilized to execute such ML models, of which MLM 2128 is an example. For instance, where applicable, MLM 2128 is a generative AI model (e.g., such as generative AI model 132 of FIG. 1) that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 2144 is used to train MLM 2128. To train MLM 2128, training data is that includes input features (attributes) and their corresponding output labels/target values (e.g., for supervised learning) is collected. A training algorithm is a computational procedure that is used so that MLM 2128 learns from the training data. Parameters/weights are internal settings of MLM 2128 that are adjusted during training by the training algorithm to reduce a difference between predictions by MLM 2128 and actual outcomes (e.g., output labels). In some examples, MLM 2128 is set with initial values for the parameters/weights. A loss function measures a dissimilarity between predictions by MLM 2128 and the target values, and the parameters/weights of MLM 2128 are adjusted to minimize the loss function. The parameters/weights are iteratively adjusted by an optimization technique, such as gradient descent. In this manner, MLM 2128 is generated through training by NPU 2144 to be used to generate inferences based on received input feature sets for particular applications. MLM 2128 is generated as a computer program or other type of algorithm configured to generate an output (e.g., a classification, a prediction/inference) based on received input features, and is stored in the form of a file or other data structure.

In examples, such training of MLM 2128 by NPU 2144 is supervised or unsupervised. According to supervised learning, input objects (e.g., a vector of predictor variables) and a desired output value (e.g., a human-labeled supervisory signal) train MLM 2128. The training data is processed, building a function that maps new data on expected output values. Example algorithms usable by NPU 2144 to perform supervised training of MLM 2128 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 2128 is an LLM, MLM 2128 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 2128 is trained to learn patterns from unlabeled data. For instance, in embodiments where MLM 2128 implements unsupervised learning techniques, MLM 2128 identifies one or more classifications or clusters to which an input belongs. During a training phase of MLM 2128 according to unsupervised learning, MLM 2128 tries to mimic the provided training data and uses the error in its mimicked output to correct itself (i.e., correct weights and biases). In further examples, NPU 2144 perform unsupervised training of MLM 2128 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 2144 need not necessarily be present in all ML model embodiments. In embodiments where ML models are present, any one or more of processor 2110, GPU 2142, and/or NPU 2144 can be present to train and/or execute MLM 2128.

One or more wireless modems 2160 can be coupled to antenna(s) (not shown) of computing device 2102 and can support two-way communications between processor 2110 and devices external to computing device 2102 through network 2104, as would be understood to persons skilled in the relevant art(s). Wireless modem 2160 is shown generically and can include a cellular modem 2166 for communicating with one or more cellular networks, such as a GSM network for data and voice communications within a single cellular network, between cellular networks, or between the mobile device and a public switched telephone network (PSTN). In examples, wireless modem 2160 also or alternatively includes other radio-based modem types, such as a Bluetooth modem 2164 (also referred to as a “Bluetooth device”) and/or Wi-Fi modem 2162 (also referred to as an “wireless adaptor”). Wi-Fi modem 2162 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 2164 is configured to communicate with another Bluetooth-capable device according to the Bluetooth short-range wireless technology standard(s) such as IEEE 802.15.1 and/or managed by the Bluetooth Special Interest Group (SIG).

Computing device 2102 can further include power supply 2182, LI receiver 2184, accelerometer 2186, and/or one or more wired interfaces 2180. Example wired interfaces 2180 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 2180 of computing device 2102 provide for wired connections between computing device 2102 and network 2104, or between computing device 2102 and one or more devices/peripherals when such devices/peripherals are external to computing device 2102 (e.g., a pointing device, display 2154, speaker 2152, camera 2136, physical keyboard 2138, etc.). Power supply 2182 is configured to supply power to each of the components of computing device 2102 and receives power from a battery internal to computing device 2102, and/or from a power cord plugged into a power port of computing device 2102 (e.g., a USB port, an A/C power port). LI receiver 2184 is useable for location determination of computing device 2102 and in examples includes a satellite navigation receiver such as a Global Positioning System (GPS) receiver and/or includes other type of location determiner configured to determine location of computing device 2102 based on received information (e.g., using cell tower triangulation, etc.). Accelerometer 2186, when present, is configured to determine an orientation of computing device 2102.

Note that the illustrated components of computing device 2102 are not required or all-inclusive, and fewer or greater numbers of components can be present as would be recognized by one skilled in the art. In examples, computing device 2102 includes one or more of a gyroscope, barometer, proximity sensor, ambient light sensor, digital compass, etc. In an example, processor 2110 and memory 2156 are co-located in a same semiconductor device package, such as being included together in an integrated circuit chip, FPGA, or system-on-chip (SOC), optionally along with further components of computing device 2102.

In embodiments, computing device 2102 is configured to implement any of the above-described features of flowcharts herein. Computer program logic for performing any of the operations, steps, and/or functions described herein is stored in storage 2120 and executed by processor 2110.

In some embodiments, server infrastructure 2170 is present in computing environment 2100 and is communicatively coupled with computing device 2102 via network 2104. Server infrastructure 2170, when present, is a network-accessible server set (e.g., a cloud-based environment or platform). As shown in FIG. 21, server infrastructure 2170 includes clusters 2172. Each of clusters 2172 comprises a group of one or more compute nodes and/or a group of one or more storage nodes. For example, as shown in FIG. 21, cluster 2172 includes nodes 2174. Each of nodes 2174 are accessible via network 2104 (e.g., in a “cloud-based” embodiment) to build, deploy, and manage applications and services. In examples, any of nodes 2174 is a storage node that comprises a plurality of physical storage disks, SSDs, and/or other physical storage devices that are accessible via network 2104 and are configured to store data associated with the applications and services managed by nodes 2174.

Each of nodes 2174, as a compute node, comprises one or more server computers, server systems, and/or computing devices. For instance, a node 2174 in accordance with an embodiment includes one or more of the components of computing device 2102 disclosed herein. Each of nodes 2174 is configured to execute one or more software applications (or “applications”) and/or services and/or manage hardware resources (e.g., processors, memory, etc.), which are utilized by users (e.g., customers) of the network-accessible server set. In examples, as shown in FIG. 21, nodes 2174 includes a node 2146 that includes storage 2148 and/or one or more of a processor 2158 (e.g., similar to processor 2110, GPU 2142, and/or NPU 2144 of computing device 2102). Storage 2148 stores application programs 2176 and application data 2178. Processor(s) 2158 operate application programs 2176 which access and/or generate related application data 2178. In an implementation, nodes such as node 2146 of nodes 2174 operate or comprise one or more virtual machines, with each virtual machine emulating a system architecture (e.g., an operating system), in an isolated manner, upon which applications such as application programs 2176 are executed.

In embodiments, one or more of clusters 2172 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 2172 are included in a datacenter in a distributed collection of datacenters. In embodiments, exemplary computing environment 2100 comprises part of a cloud-based platform.

In an embodiment, computing device 2102 accesses application programs 2176 for execution in any manner, such as by a client application and/or a browser at computing device 2102.

In an example, for purposes of network (e.g., cloud) backup and data security, computing device 2102 additionally and/or alternatively synchronizes copies of application programs 2114 and/or application data 2116 to be stored at network-based server infrastructure 2170 as application programs 2176 and/or application data 2178. In examples, operating system 2112 and/or application programs 2114 include a file hosting service client configured to synchronize applications and/or data stored in storage 2120 at network-based server infrastructure 2170.

In some embodiments, on-premises servers 2192 are present in computing environment 2100 and are communicatively coupled with computing device 2102 via network 2104. On-premises servers 2192, when present, are hosted within an organization's infrastructure and, in many cases, physically onsite of a facility of that organization. On-premises servers 2192 are controlled, administered, and maintained by IT (Information Technology) personnel of the organization or an IT partner to the organization. Application data 2198 can be shared by on-premises servers 2192 between computing devices of the organization, including computing device 2102 (when part of an organization) through a local network of the organization, and/or through further networks accessible to the organization (including the Internet). Furthermore, in examples, on-premises servers 2192 serve applications such as application programs 2196 to the computing devices of the organization, including computing device 2102. Accordingly, in examples, on-premises servers 2192 include storage 2194 (which includes one or more physical storage devices such as storage disks and/or SSDs) for storage of application programs 2196 and application data 2198 and include a processor 2190 (e.g., similar to processor 2110, GPU 2142, and/or NPU 2144 of computing device 2102) for execution of application programs 2196. In some embodiments, multiple processors 2190 are present for execution of application programs 2196 and/or for other purposes. In further examples, computing device 2102 is configured to synchronize copies of application programs 2114 and/or application data 2116 for backup storage at on-premises servers 2192 as application programs 2196 and/or application data 2198.

Embodiments described herein may be implemented in one or more of computing device 2102, network-based server infrastructure 2170, and on-premises servers 2192. For example, in some embodiments, computing device 2102 is used to implement systems, clients, or devices, or components/subcomponents thereof, disclosed elsewhere herein. In other embodiments, a combination of computing device 2102, network-based server infrastructure 2170, and/or on-premises servers 2192 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 2120. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 2114) are stored in storage 2120. Such computer programs can also be received via wired interface(s) 2160 and/or wireless modem(s) 2160 over network 2104. Such computer programs, when executed or loaded by an application, enable computing device 2102 to implement features of embodiments discussed herein. Accordingly, such computer programs represent controllers of the computing device 2102.

Embodiments are also directed to computer program products comprising computer code or instructions stored on any computer-readable medium or computer-readable storage medium. Such computer program products include the physical storage of storage 2120 as well as further physical storage types.

### VII. Additional Exemplary Embodiments

A system for generating a query language query utilizing a large language model (LLM) is described herein. The system comprises a processor circuit and a memory device. The memory device stores program code to be executed by the processor circuit. The program code comprises a pre-processor, a prompter, and/or a post-processor.

In a further embodiment of the foregoing system, the pre-processor: receives a request associated with querying a database, determines a request embedding based on the request, compares the request embedding to a first layer embedding of layer embeddings of a deep data map to determine a similarity between the request embedding and the first layer embedding satisfies first similarity criteria, the first layer embedding describing a value within a database, and determines a ranked item based on the first layer embedding.

In a further embodiment of the foregoing system, the prompter provides a prompt to the LLM to cause the LLM to generate a query language query, the prompt comprising a description of the ranked item.

In a further embodiment of the foregoing system, the post-processor: receives a first alert indicating a first variable of the query language query generated by the LLM is undefined, receives a first query embedding associated with the query language query and corresponding to the undefined first variable, compares the first query embedding to the layer embeddings to determine a first candidate variable, the first candidate variable associated with a second layer embedding of the layer embeddings, a similarity between the first query embedding and the second layer embedding satisfying second similarity criteria, substitutes in the first candidate variable for the undefined first variable in the query language query to generate a first repaired query language query, and generates a first response comprising the first repaired query language query.

In a further embodiment of the foregoing system, the pre-processor: compares the request embedding to a third layer embedding of the deep data map to determine a similarity between the request embedding and the third layer embedding satisfies third similarity criteria, the first layer embedding dependent on the third layer embedding; and determines a candidate item based on the third layer embedding, wherein the comparison of the request embedding to the first layer embedding is dependent on the candidate item.

In a further embodiment of the foregoing system, the program code comprises an embedding model interface that: receives descriptions of tables of the database; provides the descriptions of the tables to an embedding model configured to generate embeddings based on input data; and receives the layer embeddings of the deep data map from the embedding model.

In a further embodiment of the foregoing system, the embedding model interface: determines a portion of the database has been updated; and utilizes the embedding model to generate updated layer embeddings associated with the first portion of the database without generating new layer embeddings for a second portion of the database.

In a further embodiment of the foregoing system, prior to provision of the descriptions of the tables to the embedding model, the embedding model interface pre-processes the descriptions based on descriptions of columns in the tables.

In a further embodiment of the foregoing system, the request embedding corresponds to a column of the database where values of the column are from a predefined list.

In a further embodiment of the foregoing system, the request embedding corresponds to a column of the database with values that follow a derived format constructed from accessible information.

In a further embodiment of the foregoing system, the request comprises a natural language query.

In a further embodiment of the foregoing system, wherein the first layer embedding comprises at least one of: a table embedding describing a context of a table of the database; a column embedding describing a context of a column of the table; or a value embedding describing a context of the value.

In a further embodiment of the foregoing system, wherein the request embedding comprises at least one of: a table embedding describing a context of a table the query language query is to reference; a column embedding describing a context of a column the query language query is to reference; or a value embedding describing a context of a value the query language query is to reference.

In a further embodiment of the foregoing system, the post-processor returns the first response as a response of the LLM.

In a further embodiment of the foregoing system, the post-processor provides the first response to a query parser to cause the query parser to determine if the first repaired query language query is valid.

In a further embodiment of the foregoing system, the system comprises the query parser.

In a further embodiment of the foregoing system, the post-processor: receives a second alert indicating a second variable of the first repaired query language query is undefined; compares a second query embedding associated with the query language query and corresponding to the undefined second variable to the layer embeddings to determine a second candidate variable, the second candidate variable associated with a third layer embedding of the layer embeddings, a similarity between the second query embedding and the third layer embedding satisfying the similarity criteria; substitutes in the second candidate variable for the undefined second variable in the first repaired query language query to generate a second repaired query language query; and generates a second response comprising the second repaired query language query.

In a further embodiment of the foregoing system, the second alert indicating the second variable of the first repaired query language query is undefined is received from the query parser.

In a further embodiment of the foregoing system, the post-processor receives a second alert indicating a second variable of the first repaired query language query is undefined; determines exit criteria is met based on failure to repair the first repaired query language query; and returns a second response comprising the query language query generated by the LLM as a response of the LLM.

In a further embodiment of the foregoing system, the second alert indicating the second variable of the first repaired query language query is undefined is received from the query parser.

In a further embodiment of the foregoing system, the post-processor determines the exit criteria has been met by at least one of: determining similarities between a second query embedding corresponding to the undefined second variable and database embeddings of the set of database embeddings fail to satisfy the similarity criteria; determining a number of undefined variables in the query language query or repaired query language query satisfies undefined variable criteria; or determining a number of attempts to repair the query language query satisfies repair attempt criteria.

In a further embodiment of the foregoing system, the query language query comprises a defined second variable. The post-processor: receives a second query embedding associated with the query language query and corresponding to the defined second variable; identifies a table of the database based on the second query embedding, the identified table comprising a third variable associated with a third layer embedding and a fourth variable associated with the second layer embedding, a similarity between the second query embedding and the third layer embedding satisfying similarity criteria; and compares the first query embedding to the second layer embedding to determine the fourth variable as the first candidate variable.

In a further embodiment of the foregoing system, the query embedding comprises at least one of: a table embedding describing a context of a table of the database; a column embedding describing a context of a column of the table; and a value embedding describing a context of a value of the column.

In a further embodiment of the foregoing system, wherein the undefined variable corresponds to: a name of a table of the database; a name of a column of data of the database; or a value stored in the database.

A method for prompting an LLM is described herein. The method comprises: receiving a request associated with querying a database; determining a request embedding based on the request; comparing the request embedding to a first layer embedding of a deep data map to determine a similarity between the request embedding and the first layer embedding satisfies first similarity criteria, the first layer embedding describing a first value within a database; determining a ranked item based on the first layer embedding; including a description of the ranked item in a prompt; and providing the prompt to the LLM to cause the LLM to generate a query language query.

In a further embodiment of the foregoing method for prompting an LLM, the method further comprises: comparing the request embedding to a second layer embedding of the deep data map to determine a similarity between the request embedding and the second layer embedding satisfies second similarity criteria, the first layer embedding dependent on the second layer embedding; and determining a candidate item based on the second layer embedding, wherein said comparing the request embedding to the first layer embedding is dependent on the candidate item.

In a further embodiment of the foregoing method for prompting an LLM, the method further comprises: receiving descriptions of tables of the database; providing the descriptions of the tables to an embedding model configured to generate embeddings based on input data; and receiving layer embeddings of the deep data map from the embedding model, the layer embeddings comprising the first layer embedding.

In a further embodiment of the foregoing method for prompting an LLM, the method further comprises: determining a first portion of the database has been updated; and utilizing the embedding model to generate layer embeddings associated with the first portion of the database without generating layer embeddings for a second portion of the database.

In a further embodiment of the foregoing method for prompting an LLM, prior to the descriptions of the tables being provided to the embedding model, pre-processing the descriptions of the tables based on descriptions of columns in the tables.

In a further embodiment of the foregoing method for prompting an LLM, the request embedding corresponds to a column of the database where values of the column are from a predefined list.

In a further embodiment of the foregoing method for prompting an LLM, the request embedding corresponds to a column of the database with values that follow a derived format constructed from accessible information.

In a further embodiment of the foregoing method for prompting an LLM, wherein the request comprises a natural language query.

In a further embodiment of the foregoing method for prompting an LLM, the first layer embedding comprises at least one of: a table embedding describing a context of a table of the database; a column embedding describing a context of a column of the table; or a value embedding describing a context of the value.

A method for correcting LLM output is described herein. The method comprises: receiving a first alert indicating a first variable of a query language query generated by an LLM is undefined, the query language query corresponding to a prompt previously provided to the LLM; receiving a first query embedding associated with the query language query and corresponding to the undefined first variable; comparing the first query embedding to a set of database embeddings to determine a first candidate variable, the first candidate variable associated with a first database embedding of the set of database embeddings, a similarity between the first query embedding and the first database embedding satisfying similarity criteria; substituting in the first candidate variable for the undefined first variable in the query language query to generate a first repaired query language query; and generating a first response comprising the first repaired query language query.

In a further embodiment of the foregoing method for correcting LLM output, the method further comprises returning the first response as a response of the LLM.

In a further embodiment of the foregoing method for correcting LLM output, the method further comprises providing the first response to a query parser to cause the query parser to determine if the first repaired query language query is valid.

In a further embodiment of the foregoing method for correcting LLM output, the method further comprises: receiving, from the query parser, a second alert indicating a second variable of the first repaired query language query is undefined; comparing a second query embedding associated with the query language query and corresponding to the undefined second variable to the set of database embeddings to determine a second candidate variable, the second candidate variable associated with a second database embedding of the set of database embeddings, a similarity between the second query embedding and the second database embedding satisfying the similarity criteria; substituting in the second candidate variable for the undefined second variable in the first repaired query language query to generate a second repaired query language query; and generating a second response comprising the second repaired query language query.

In a further embodiment of the foregoing method for correcting LLM output, the method further comprises: receiving, from the query parser, a second alert indicating a second variable of the first repaired query language query is undefined; determining exit criteria is met based on failure to repair the first repaired query language query; and returning a second response comprising the query language query generated by the LLM as a response of the LLM.

In a further embodiment of the foregoing method for correcting LLM output, said determining the exit criteria has been met comprises at least one of: determining similarities between a second query embedding corresponding to the undefined second variable and database embeddings of the set of database embeddings fail to satisfy the similarity criteria; determining a number of undefined variables in the query language query or repaired query language query satisfies undefined variable criteria; or determining a number of attempts to repair the query language query satisfies repair attempt criteria.

In a further embodiment of the foregoing method for correcting LLM output, the query language query comprises a defined second variable. The method further comprises: receiving a second query embedding associated with the query language query and corresponding to the defined second variable; and wherein said comparing the first query embedding to a set of database embeddings to determine a first candidate variable comprises: identifying a table of the database based on the second query embedding, the identified table comprising a third variable associated with a second database embedding and a fourth variable associated with the first database embedding, a similarity between the second query embedding and the second database embedding satisfying similarity criteria, and comparing the first query embedding to the first database embedding to determine the fourth variable as the first candidate variable.

In a further embodiment of the foregoing method for correcting LLM output, the query embedding comprises at least one of: a table embedding describing a context of a table of the database; a column embedding describing a context of a column of the table; and a value embedding describing a context of a value of the column.

In a further embodiment of the foregoing method for correcting LLM output, the undefined variable corresponds to: a name of a table of the database; a name of a column of data of the database; or a value stored in the database.

In a further embodiment of the foregoing method for correcting LLM output, the method further comprises obtaining the set of database embeddings from a deep data map.

A computer-readable storage medium encoded with program instructions that, when executed by a processor circuit, perform any of the foregoing methods described herein.

In a further embodiment of any of the foregoing systems, methods, and/or computer readable storage medium, a generative AI model other than an LLM is utilized.

### VIII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, example embodiments have been described with respect to LLMs; however, it is also contemplated herein that embodiments may utilize other types of generative AI models (e.g., a generative adversarial network (GAN), a multimodal model, and/or the like). For instance, an implementation of the described systems and/or methods may leverage a multimodal model that inputs and/or outputs more than one modality (e.g., text and images).

Moreover, according to the described embodiments and techniques, any components of systems, computing devices, servers, applications, embedding models, generative AI models, database engines, databases, language conversion engines, pre-processors, post-processors, embedding model interfaces, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system for generating a query language query utilizing a large language model (LLM), comprising:
a processor circuit; and
a memory device that stores program code to be executed by the processor circuit, the program code comprising:
a pre-processor that:
receives a request associated with querying a database,
determines a request embedding based on the request,
compares the request embedding to a first layer embedding of layer embeddings of a deep data map to determine a similarity between the request embedding and the first layer embedding satisfies first similarity criteria, the first layer embedding describing a value within a database, and
determines a ranked item based on the first layer embedding;
a prompter that:
provides a prompt to the LLM to cause the LLM to generate a query language query, the prompt comprising a description of the ranked item; and
a post-processor that:
receives a first alert indicating a first variable of the query language query generated by the LLM is undefined,
obtains a first query embedding associated with the query language query and corresponding to the undefined first variable,
compares the first query embedding to the layer embeddings to determine a first candidate variable, the first candidate variable associated with a second layer embedding of the layer embeddings, a similarity between the first query embedding and the second layer embedding satisfying second similarity criteria,
substitutes in the first candidate variable for the undefined first variable in the query language query to generate a first repaired query language query, and
generates a first response comprising the first repaired query language query.

2. The system of claim 1, wherein the pre-processor:
compares the request embedding to a third layer embedding of the deep data map to determine a similarity between the request embedding and the third layer embedding satisfies third similarity criteria, the first layer embedding dependent on the third layer embedding; and
determines a candidate item based on the third layer embedding, wherein the comparison of the request embedding to the first layer embedding is dependent on the candidate item.

3. The system of claim 1, the program code comprises an embedding model interface that:
receives descriptions of tables of the database;
provides the descriptions of the tables to an embedding model configured to generate embeddings based on input data; and
receives the layer embeddings of the deep data map from the embedding model.

4. The system of claim 1, wherein the post-processor:
receives a second alert indicating a second variable of the first repaired query language query is undefined;
compares a second query embedding associated with the query language query and corresponding to the undefined second variable to the layer embeddings to determine a second candidate variable, the second candidate variable associated with a third layer embedding of the layer embeddings, a similarity between the second query embedding and the third layer embedding satisfying the similarity criteria;
substitutes in the second candidate variable for the undefined second variable in the first repaired query language query to generate a second repaired query language query; and
generates a second response comprising the second repaired query language query.

5. The system of claim 1, wherein the post-processor:
receives a second alert indicating a second variable of the first repaired query language query is undefined;
determines exit criteria is met based on failure to repair the first repaired query language query; and
returns a second response comprising the query language query generated by the LLM as a response of the LLM.

6. The system of claim 1, wherein the first layer embedding comprises at least one of:
a table embedding describing a context of a table of the database;
a column embedding describing a context of a column of the table; or
a value embedding describing a context of the value.

7. A computer-implemented method for prompting a large language model (LLM), the method comprising:
receiving a request associated with querying a database;
determining a request embedding based on the request;
comparing the request embedding to a first layer embedding of a deep data map to determine a similarity between the request embedding and the first layer embedding satisfies first similarity criteria, the first layer embedding describing a value within a database;
determining a ranked item based on the first layer embedding;
including a description of the ranked item in a prompt; and
providing the prompt to the LLM to cause the LLM to generate a query language query.

8. The computer-implemented method of claim 7, further comprising:
comparing the request embedding to a second layer embedding of the deep data map to determine a similarity between the request embedding and the second layer embedding satisfies second similarity criteria, the first layer embedding dependent on the second layer embedding; and
determining a candidate item based on the second layer embedding, wherein said comparing the request embedding to the first layer embedding is dependent on the candidate item.

9. The computer-implemented method of claim 7, further comprising:
receiving descriptions of tables of the database;
providing the descriptions of the tables to an embedding model configured to generate embeddings based on input data; and
receiving layer embeddings of the deep data map from the embedding model, the layer embeddings comprising the first layer embedding.

10. The computer-implemented method of claim 9, further comprising:
determining a first portion of the database has been updated; and
utilizing the embedding model to generate updated layer embeddings associated with the first portion without generating new layer embeddings for a second portion of the database.

11. The computer-implemented method of claim 9, further comprising:
prior to said providing the descriptions of the tables to the embedding model, pre-processing the descriptions based on descriptions of columns in the tables.

12. The computer-implemented method of claim 7, wherein the request embedding corresponds to a column of the database where values of the column are from a predefined list.

13. The computer-implemented method of claim 7, wherein the request comprises a natural language query.

14. A computer-implemented method for correcting large language model (LLM) output, the computer-implemented method comprising:
receiving a first alert indicating a first variable of a query language query generated by an LLM is undefined, the query language query corresponding to a prompt previously provided to the LLM;
obtaining a first query embedding associated with the query language query and corresponding to the undefined first variable;
comparing the first query embedding to a set of database embeddings to determine a first candidate variable, the first candidate variable associated with a first database embedding of the set of database embeddings, a similarity between the first query embedding and the first database embedding satisfying similarity criteria;
substituting in the first candidate variable for the undefined first variable in the query language query to generate a first repaired query language query; and
generating a first response comprising the first repaired query language query.

15. The computer-implemented method of claim 14, further comprising:
providing the first response to a query parser to cause the query parser to determine if the first repaired query language query is valid.

16. The computer-implemented method of claim 15, further comprising:
receiving, from the query parser, a second alert indicating a second variable of the first repaired query language query is undefined;
comparing a second query embedding associated with the query language query and corresponding to the undefined second variable to the set of database embeddings to determine a second candidate variable, the second candidate variable associated with a second database embedding of the set of database embeddings, a similarity between the second query embedding and the second database embedding satisfying the similarity criteria;
substituting in the second candidate variable for the undefined second variable in the first repaired query language query to generate a second repaired query language query; and
generating a second response comprising the second repaired query language query.

17. The computer-implemented method of claim 15, further comprising:
receiving, from the query parser, a second alert indicating a second variable of the first repaired query language query is undefined;
determining exit criteria is met based on failure to repair the first repaired query language query; and
returning a second response comprising the query language query generated by the LLM as a response of the LLM.

18. The computer-implemented method of claim 17, wherein said determining the exit criteria has been met comprises at least one of:
determining similarities between a second query embedding corresponding to the undefined second variable and database embeddings of the set of database embeddings fail to satisfy the similarity criteria;
determining a number of undefined variables in the query language query or repaired query language query satisfies undefined variable criteria; or
determining a number of attempts to repair the query language query satisfies repair attempt criteria.

19. The computer-implemented method of claim 14, wherein the query language query comprises a defined second variable, and wherein said method further comprises:
receiving a second query embedding associated with the query language query and corresponding to the defined second variable; and
wherein said comparing the first query embedding to a set of database embeddings to determine a first candidate variable comprises:
identifying a table of the database based on the second query embedding, the identified table comprising a third variable associated with a second database embedding and a fourth variable associated with the first database embedding, a similarity between the second query embedding and the second database embedding satisfying similarity criteria, and
comparing the first query embedding to the first database embedding to determine the fourth variable as the first candidate variable.

20. The computer-implemented method of claim 14, wherein the undefined variable corresponds to:
a name of a table of the database;
a name of a column of data of the database; or
a value stored in the database.
